(19) United States
(12) Patent Application Publication
(10) Pub. No.: US 2026/0371069 A1
(43) Pub. Date: Nov. 19, 2026

(54) SYSTEM AND A METHOD FOR ELECTROCARDIOGRAPHIC PREDICTION OF COMPUTED TOMOGRAPHY-BASED HIGH CORONARY CALCIUM SCORE

(71) Applicant: Mayo Foundation for Medical Education and Research, Rochester, MN (US)

(72) Inventors: Itzhak Zachi Attia, Rochester, MN (US); Samir Awasthi, Cambridge, MA (US); Francisco Lopez-Jimenez, Rochester, MN (US)

(73) Assignee: Mayo Foundation for Medical Education and Research, Rochester, MN (US)

(21) Appl. No.: 19/749,037

(22) Filed: Jul. 21, 2026

Related U.S. Application Data
(63) Continuation-in-part of application No. 19/649,971, filed on Apr. 16, 2026.
Application No. 19/649,971 is a continuation of application No. 18/842,012, filed on Apr. 29, 2022.
(60) Provisional application No. 63/342,275, filed on May 16, 2022.

(51) Int. Cl. H04W 8/24; H04B 7/06; H04B 17/318; H04B 17/336; H04L 41/16

(52) U.S. Cl. CPC H04W 8/24; H04B 7/0626; H04B 17/328; H04B 17/336; H04L 41/16

(57) ABSTRACT

A method of and system for electrocardiographic prediction of computed tomography-based high coronary calcium score are disclosed. The method includes receiving, using at least a processor, voltage-time data of a subject, wherein the voltage-time data includes voltage data from a plurality of leads and generating, using the at least a processor, a feature vector as a function of the voltage-time data. The method further includes processing, using the at least a processor and a trained learning system including one or more CNNs, the feature vector to generate one or more CNN outputs and determining, using the at least a processor, an indication of cardiovascular risk for the subject as a function of the one or more CNN outputs.

### CROSS-REFERENCE TO RELATED APPLICATIONS

This application is a continuation-in-part of U.S. Non-Provisional patent application Ser. No. 19/649,971, filed Apr. 16, 2026, and entitled SYSTEM AND A METHOD FOR ELECTROCARDIOGRAPHIC PREDICTION OF COMPUTED TOMOGRAPHY-BASED HIGH CORONARY CALCIUM SCORE (CAC)”, which is a continuation of U.S. Non-Provisional patent application Ser. No. 18/642,012, filed on Apr. 22, 2024, now U.S. Pat. No. 12,622,650 issued May 12, 2026, and entitled “SYSTEM AND A METHOD FOR ELECTROCARDIOGRAPHIC PREDICTION OF COMPUTED TOMOGRAPHY-BASED HIGH CORONARY CALCIUM SCORE (CAC),” which is a continuation of Patent Cooperation Treaty (PCT) Application No. PCT/US2023/022325, filed on May 16, 2023, and entitled “DEEP LEARNING ENABLED ELECTROCARDIOGRAPHIC PREDICTION OF COMPUTER TOMOGRAPHY-BASED HIGH CORONARY CALCIUM SCORE (CAC)”, which claims the benefit of priority to U.S. Provisional Patent Application Ser. No. 63/342,275, filed on May 16, 2022, and titled “DEEP LEARNING ENABLED ELECTROCARDIOGRAPHIC PREDICTION OF COMPUTER TOMOGRAPHY-BASED HIGH CORONARY CALCIUM SCORE (CAC)”, all of which are incorporated by reference herein in their entirety.

### FIELD OF THE INVENTION

The present invention generally relates to the field of artificial intelligence. In particular, the present invention is directed to a system and a method for electrocardiographic prediction of computed tomography-based high coronary calcium score.

### BACKGROUND

Embodiments of the present disclosure relate to methods for the detection and evaluation of coronary artery calcium and treatment of subjects identified for cardiovascular risk. Computed tomography-based coronary artery calcium (CAC) scoring is recommended in adults with unclear cardiovascular risk to inform preventative strategies and statin prescription. CAC has major limitations as it exposes the individual to radiation, is costly, not readily available everywhere and requires scoring by an expert radiologist. Thus, there is a long felt and unmet need for improved methods to detect and evaluate CAC.

### SUMMARY OF THE DISCLOSURE

In some aspects, the techniques described herein relate to a method of electrocardiographic prediction of computed tomography-based high coronary calcium score. The method includes receiving, using at least a processor, voltage-time data of a subject, wherein the voltage-time data includes voltage data from a plurality of leads, generating, using the at least a processor, a feature vector as a function of the voltage-time data, wherein the feature vector includes one or more time-series of values indicating an amplitude of an electrocardiogram (ECG) for the plurality of leads, processing, using the at least a processor and a trained learning system including one or more convolutional neural networks (CNNs), the feature vector to generate one or more CNN outputs associated with the subject, wherein the one or more CNNs includes a first CNN configured to generate an indication of a level of coronary artery calcium (CAC), and determining, using the at least a processor, an indication of cardiovascular risk for the subject as a function of the one or more CNN outputs, wherein the indication of cardiovascular risk corresponds to a likelihood of the subject having or developing a cardiovascular condition within a future time interval.

In some aspects, the techniques described herein relate to a system for electrocardiographic prediction of computed tomography-based high coronary calcium score. The system includes at least a processor, a computer readable storage medium communicatively connected to the at least a processor, wherein the computer readable storage medium contains instructions configuring the at least processor receive voltage-time data of a subject, wherein the voltage-time data includes voltage data from a plurality of leads, generate a feature vector as a function of the voltage-time data, wherein the feature vector includes one or more time-series of values indicating an amplitude of an electrocardiogram (ECG) for the plurality of leads, process, using a trained learning system including one or more convolutional neural networks (CNNs), the feature vector to generate one or more CNN outputs associated with the subject, wherein the one or more CNNs includes a first CNN configured to an indication of a level of coronary artery calcium (CAC), and determine an indication of cardiovascular risk for the subject as a function of the one or more CNN outputs, wherein the indication of cardiovascular risk corresponds to a likelihood of the subject having or developing a cardiovascular condition within a future time interval.

In some aspects of the invention, disclosed herein are methods comprising receiving voltage-time data of a subject, the voltage-time data comprising voltage data of a plurality of leads of an electrocardiograph; generating a feature vector from the voltage-time data; providing the feature vector to a pretrained learning system; and receiving from the pretrained learning system an indication of the level of CAC in the subject.

Aspects of the invention, as disclosed herein, also include a system comprising: an electrocardiograph comprising a plurality of leads; a computing node comprising a computer readable storage medium having program instructions embodied therewith, the program instructions executable by a processor of the computing node to cause the processor to perform a method comprising: receiving voltage-time data of a subject from the echocardiograph, the voltage-time data comprising voltage data of the plurality of leads; generating a feature vector from the voltage-time data; providing the feature vector to a pretrained learning system; and receiving from the pretrained learning system an indication of the level of CAC in the subject.

In certain aspects of the invention, disclosed herein is a computer program product for evaluation of CAC, the computer program product comprising a computer readable storage medium having program instructions embodied therewith, the program instructions executable by a processor to cause the processor to perform a method comprising: receiving voltage-time data of a subject from the echocardiograph, the voltage-time data comprising voltage data of the plurality of leads; generating a feature vector from the voltage-time data; providing the feature vector to a pretrained learning system; and receiving from the pretrained learning system an indication of the level of CAC in the subject.

Disclosed herein are systems and methods for identifying ASCVD risk using electrocardiographic data. In some embodiments, an ECG-AI algorithm leverages a first neural network configured to identify elevated coronary artery calcification and a second neural network configured to identify regional wall motion abnormalities. Outputs of the first neural network and the second neural network may be used to identify populations having higher ASCVD event rates and/or shorter times to ASCVD events.

In some embodiments, the disclosed ECG-AI algorithm is implemented as software as a medical device (SaMD) configured to analyze a 12-lead ECG. In some embodiments, the SaMD may be integrated into a third-party healthcare software application. The third-party healthcare software application may facilitate importation of digital ECG data and furnishing of the digital ECG data as input to the disclosed subject device. In some embodiments, the device analyzes ten seconds or longer of ECG waveform digital samples collected during a standard ECG and outputs a ternary result for identification of ASCVD risk, optionally along with additional output. The output may be presented on an electronic display by an integrating application. In some embodiments, the device may further output error information, such as software function error codes. Errors may result from software malfunction, ECG input issues, or both, and may be configured not to produce a positive or negative detection output.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A illustrates a schematic view of an exemplary embodiment of a system for detecting or otherwise predicting coronary artery calcium (CAC);

FIG. 1B illustrates a schematic view of an exemplary embodiment of a system for detecting or otherwise predicting coronary artery calcium (CAC) and cardiovascular risk;

FIG. 2A illustrates an exemplary flowchart illustrating a method of detecting or otherwise predicting CAC according to embodiments of the present disclosure;

FIG. 2B illustrates an exemplary flowchart illustrating a method of detecting or otherwise predicting coronary artery calcium (CAC) and cardiovascular risk;

FIG. 3 illustrates an exemplary depiction of a computing node according to an embodiment of the present disclosure;

FIG. 4 illustrates an exemplary depiction of a receiver operating characteristic curve (ROC) of the convolutional neural network used to identify patients with a CAC score 2: 300;

FIG. 5 illustrates an exemplary depiction of a relationship between the AI-ECG probability and the Calcium score level; and

FIG. 6 illustrates a table of network ROC and sensitivity and specificity across subgroups;

FIG. 7 illustrates a diagram of an exemplary convolutional neural network;

FIG. 8 illustrates a block diagram of an exemplary machine-learning module;

FIG. 9 illustrates a diagram of an exemplary neural network;

FIG. 10 illustrates a block diagram of an exemplary node in a neural network; and

FIG. 11 illustrates a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

Approximately half of all deaths resulting from cardiovascular disease are caused by coronary artery disease (CAD). Patients experiencing nonfatal acute myocardial infarction or sudden death may have had no previous symptoms. Thus, identification of individuals, including asymptomatic individuals, at greater risk of experiencing future cardiovascular events is critical for the implementation of preventive strategies. Characterization of coronary-artery calcification shows equivalence with total coronary atherosclerosis load and with risk of cardiovascular events. However, acquisition and analysis of CAC data is performed by computed tomography which is expensive, requires highly specialized equipment and trained technicians, not readily accessible, and exposes the individual to radiation. Accordingly, the invention provided herein is based, at least in part, on a deep learning (DL) algorithm designed and developed to predict CAC score from 12-lead electrocardiograms (ECG-AI).

Atherosclerotic cardiovascular disease (ASCVD) is a leading cause of mortality worldwide. In the United States alone, myocardial infarction occurs at a high frequency. Evidence-based ASCVD risk estimators have been developed to facilitate initiation of measures for primary prevention of ASCVD, including lipid-lowering therapy. Widely adopted estimators include pooled cohort equations (PCE), which estimate ten-year risk of ASCVD events, such as death due to coronary heart disease, nonfatal myocardial infarction, and fatal or nonfatal stroke, based on clinical and demographic information. However, such estimators may overestimate or underestimate risk in groups having risk modifiers that are not included in the underlying calculators.

Additional risk equations, such as Predicting Risk of Events (PREVENT) equations, have been developed to address limitations associated with existing ASCVD risk estimators. PREVENT may be derived from general population cohorts and electronic health record (EHR) data and may be externally validated using additional cohort and EHR datasets. In some implementations, a threshold of about 7.5% ten-year risk may be used to demarcate lower or moderate risk from moderate or higher risk.

Coronary artery calcium (CAC) scoring can provide additional value by reclassifying estimated risk for some patients when a decision regarding initiation of therapy is unclear. However, evidence regarding when to obtain CAC scoring remains evolving. As a result, CAC scoring may be underutilized, including due to limited health-insurance coverage, notwithstanding substantial clinical utility and potential clinical impact.

Approaches leveraging artificial-intelligence-enabled analysis of electrocardiograms (ECG-AI) to predict whether a patient has an elevated CAC score have demonstrated good discriminatory capacity. For example, published CAC ECG-AI models have demonstrated area under the receiver operating characteristic curve (AUROC) values in ranges of about 0.75 to about 0.77 for discriminating CAC score greater than or equal to 100, and about 0.77 to about 0.80 for discriminating CAC score greater than or equal to about 300 to about 400. Such ECG-AI approaches can enable accessible and affordable risk stratification prior to CAC scoring. However, coronary artery disease (CAD) exists on a spectrum that includes risk factors, non-obstructive atherosclerosis, obstructive atherosclerosis, and myocardial infarction, including silent myocardial infarction.

Disclosed herein is the development of an artificial intelligence (AI)-based tool to detect coronary artery calcium (CAC) from a standard 12-lead electrocardiogram (ECG). To test AI-driven models for early detection of CAC, a novel AI-electrocardiogram (ECG) network was developed.

Convolutional neural networks offer a comprehensive approach to analyzing and interpreting the vast amount of data generated in a single ECG. Algorithms were developed using 12-lead ECG data from 43,210 consecutive patients that from 1997-2020 underwent clinically indicated CAC and ECG within 1 year. In some embodiments, the invention may be performed using single-lead and 6-lead ECG subsets. Furthermore, because smartphone-enabled electrodes permit point-of-care diagnosis with single-lead and 6-lead options, compatible networks may be developed and tested.

All models used voltage-time information from 12-lead ECGs as inputs. Modeling techniques explored included convolutional neural networks with differing structures such as using all 12 leads as a single input.

Accordingly, in some aspects of the invention, disclosed herein are methods comprising receiving voltage-time data of a subject, the voltage-time data comprising voltage data of a plurality of leads of an electrocardiograph; generating a feature vector from the voltage-time data, wherein the feature vector contains a time-series of values indicating an amplitude of the voltage-time data for the plurality of leads; providing the feature vector to a pretrained learning system; and receiving from the pretrained learning system an indication of the level of CAC in the subject. Generating the feature vector may comprise generating a spectrogram based on the voltage data of the plurality of leads. In some embodiments generating the feature vector comprises grouping the voltage data of the plurality of leads into a plurality of subsets.

In some embodiments, such methods further comprise receiving demographic information of the subject, wherein generating the feature vector comprises adding the demographic information to the feature vector. In some such embodiments, the method further comprises receiving genomic information of the subject. Generating the feature vector may comprise adding the genomic information to the feature vector. Without being bound by any particular methodology or theory, said genomic data may be derived from a biological sample that is derived from a patient predisposed to increased cardiovascular risk, e.g., family history or genetic and/or protein markers. In some such embodiments, the learning system comprises a convolutional neural network. Such convolutional neural networks may comprise at least one residual connection.

In some embodiments, the voltage-time data of a subject is received from an electrocardiograph. In further embodiments, the voltage-time data of a subject is received from an electronic medical record.

In some embodiments, the method further comprises providing the indication to an electronic health record system for storage in a health record associated with the subject. In some embodiments, the method further comprises providing the indication to a computing node for display to a user.

In some embodiments of the methods disclosed herein, the feature vector comprises a matrix having a plurality of rows and a plurality of columns, the plurality of rows corresponding to a temporal dimension and the plurality of columns corresponding to a spatial dimension. In some such embodiments, each of the plurality of rows correspond to one of the plurality of leads and each of the plurality of columns corresponds to a timestamp. In some embodiments, the temporal dimension has a resolution of 500 Hz. The convolutional neural network disclosed herein may comprise at least nine convolutional blocks and two fully connected blocks.

In some embodiments, the period of time of the voltage-time data describes multiple cardiac cycles of the subject.

In some embodiments, the method further comprises presenting the indication of the level of CAC in the subject to a healthcare provider associated with the subject.

In some embodiments, the voltage-time data describes a single-lead ECG of the subject. In some embodiments, the single-lead ECG corresponds to one of the leads of a 12-lead ECG. In some embodiments, one of the leads of the 12-lead ECG to which the single-lead corresponds is Lead 1, Lead 2, Lead 3, AvF, AvL. AvR, or V1-V6.

In some embodiments, the voltage-time data is limited to describing a single beat of the voltage-time data from an ECG of the subject.

In some embodiments, the voltage-time data is limited to describing a single averaged beat of the voltage-time data from an ECG of the subject. In some embodiments, the voltage-time data is limited to describing a single median beat of the voltage-time data from an ECG of the subject. In some embodiments, the voltage-time data describes a single beat and the voltage-time data is multidimensional and extracted from a Vectorcardiogram. In some embodiments, the time-voltage data describes a normal sinus rhythm for the subject. In some embodiments, the feature vector is based on features of the subject's normal sinus rhythm.

In some embodiments, the time-voltage data spans a time interval that is less than or equal to thirty seconds. In some embodiments, the time-voltage data spans a time interval that is less than or equal to ten minutes.

In some embodiments, the subject is a mammal, and the mammal is a human.

In some embodiments, the time-voltage data of the subject is based on fewer than twelve leads.

In some embodiments, the indication of the level of CAC in the subject indicates at least one possible treatment plan. In some embodiments, the at least one possible monitoring or treatment plan includes administering a therapy. In some embodiments, the at least one possible treatment plan includes collecting a second series of voltage-time data.

In some embodiments, the method further comprises obtaining data describing a non-ECG profile for the mammal; generating one or more second neural network inputs representing the non-ECG profile for the subject; and processing the first neural network input along with the one or more second neural network inputs with the neural network to generate the feature vector.

In some embodiments, the indication of the level of CAC in the subject indicates at least a threshold likelihood of the subject experiencing CAC. In some embodiments, the method further comprises determining a treatment to lower the level of CAC in the subject in response to the indication of at least a threshold likelihood of the subject experiencing CAC.

In some embodiments, the voltage-time data from the subject was recorded over a first time interval, and the method further comprises obtaining a second neural network input, the second neural network input representing a second voltage-time data of the subject that was recorded over a second time interval, the first time interval and the second time interval separated by a third time interval; and processing the first neural network input along with the second neural network input with the neural network to generate the feature vector for the subject. In some embodiments, the third time interval is at least a minute, an hour, a day, a week, or a month. In some embodiments, the neural network further processes, along with the first neural network input and the second neural network input, a third neural network input that indicates a length of the third time interval between the first and second time intervals when the first voltage-time data and the second voltage-time data were recorded, respectively.

In some embodiments, the pretrained learning system is trained by receiving a training set of voltage-time data from a plurality of CAC patients. In some embodiments, the training set of voltage-time data is from one of a retrospective cohort subset or a prospective cohort subset.

In some embodiments, the voltage-time data comprises analog data characterizing ECG signals. In some embodiments, the voltage-time data comprises numerical values specifying amplitudes of ECG signals. In some embodiments, the voltage-time data comprises image data characterizing ECG signals. In some embodiments, the image data characterizing the ECG signals is in pixel form, including TIFF, PNG, or PDF file type.

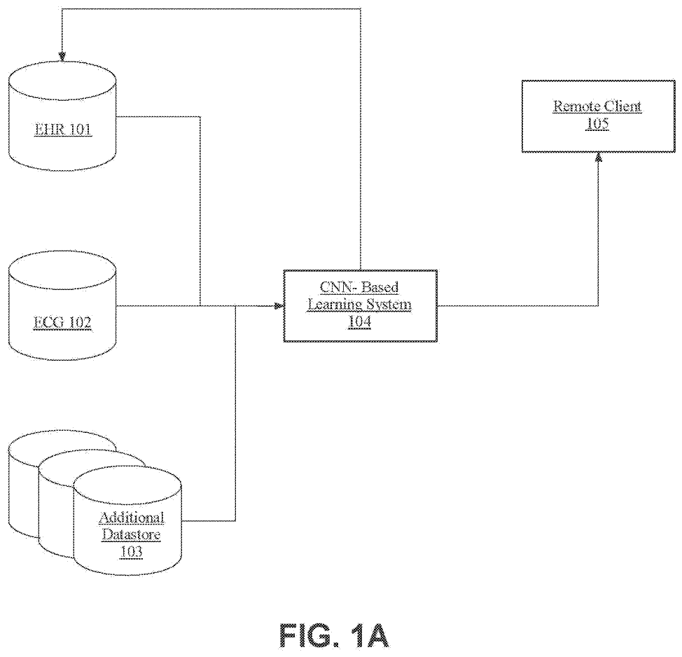

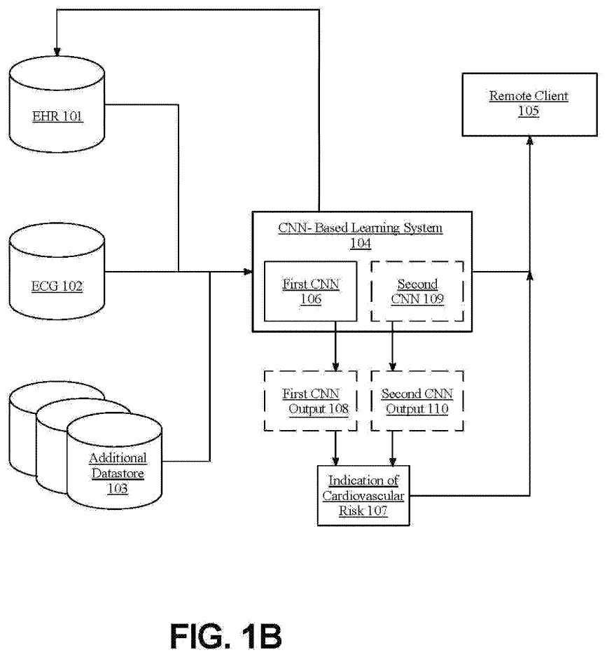

Referring now to FIGS. 1A-B, in FIG. 1A, a system for detecting or otherwise predicting the level of CAC is illustrated according to embodiments of the present disclosure. As outlined above, in various embodiments, patient information, including electrocardiogram (ECG) data, is provided to a learning system in order to determine the level of CAC. Thus, aspects of the invention, as disclosed herein, also include a system comprising: an electrocardiograph comprising a plurality of leads; a computing node comprising a computer readable storage medium having program instructions embodied therewith, the program instructions executable by a processor of the computing node to cause the processor to perform a method comprising: receiving voltage-time data of a subject from the echocardiograph, the voltage-time data comprising voltage data of the plurality of leads; generating a feature vector from the voltage-time data; providing the feature vector to a pretrained learning system; and receiving from the pretrained learning system an indication of the level of CAC in the subject. Generating the feature vector may comprise generating a spectrogram based on the voltage data of the plurality of leads. In some embodiments generating the feature vector comprises grouping the voltage data of the plurality of leads into a plurality of subsets. For the purposes of this disclosure, a “feature vector” is a data representation derived from voltage-time data. In some embodiments, structured data representation may encode information usable by a computational model to characterize electrical, temporal, spatial, morphological, or risk-associated attributes of an electrocardiogram.

With continued reference to FIGS. 1A-B, such systems further comprise receiving demographic information of the subject, wherein generating the feature vector comprises adding the demographic information to the feature vector. In some such embodiments, the system further comprises receiving genomic information of the subject. Generating the feature vector may comprise adding the genomic information to the feature vector. Without being bound by any particular methodology or theory, said genomic data may be derived from a biological sample that is derived from a patient predisposed to increased cardiovascular risk, e.g., family history or genetic and/or protein markers. In some such embodiments, the learning system comprises a convolutional neural network. Such convolutional neural networks may comprise at least one residual connection. For the purposes of this disclosure, a “learning system” is a computational system including one or more trained models. In some cases, learning system 104 may be configured to receive one or more inputs, process the one or more inputs according to learned parameters, and generate one or more outputs corresponding to a predicted condition, class, score, probability, or other inference.

With continued reference to FIGS. 1A-B, the voltage-time data of a subject is received from an electrocardiograph. In further embodiments, the voltage-time data of a subject is received from an electronic medical record.

With continued reference to FIGS. 1A-B, the system further comprises providing the indication to an electronic health record system for storage in a health record associated with the subject. In some embodiments, the system further comprises providing the indication to a computing node for display to a user.

With continued reference to FIGS. 1A-B, the feature vector comprises a matrix having a plurality of rows and a plurality of columns, the plurality of rows corresponding to a temporal dimension and the plurality of columns corresponding to a spatial dimension. In some such embodiments, each of the plurality of columns correspond to one of the plurality of leads and each of the plurality of columns corresponds to a timestamp. In some embodiments, the temporal dimension has a resolution of 500 Hz. In some embodiments, the convolutional neural network comprises at least nine convolutional blocks and two fully connected blocks.

With continued reference to FIGS. 1A-B, patient data may be received from electronic health record (EHR) 101. An electronic health record (EHR), or electronic medical record (EMR), may refer to the systematized collection of patient and population electronically-stored health information in a digital format. These records can be shared across different health care settings. Records may be shared through network-connected, enterprise-wide information systems or other information networks and exchanges. EHRs may include a range of data, including demographics, medical history, medication and allergies, immunization status, laboratory test results, radiology images, vital signs, personal statistics like age and weight, and billing information. EHR systems may be designed to store data and capture the state of a patient over time. In this way, the need to track down a patient's previous paper medical records is eliminated.

With continued reference to FIGS. 1A-B, electrocardiogram (ECG) data may be received directly from an electrocardiography device. In an exemplary 12-lead ECG, ten electrodes are placed on the patient's limbs and on the surface of the chest. The overall magnitude of the heart's electrical potential is then measured from twelve different angles (leads) and is recorded over a period of time (usually ten seconds). In this way, the overall magnitude and direction of the heart's electrical depolarization is captured at each moment throughout the cardiac cycle.

With continued reference to FIGS. 1A-B, additional datastores 103, may include further patient information as set out herein. Suitable datastores include databases, flat files, and other structures known in the art.

With continued reference to FIGS. 1A-B, it will be appreciated that ECG data may be stored in an EHR for later retrieval. It will also be appreciated that ECG data may be cached, rather than delivered directly to a learning system for further processing.

With continued reference to FIGS. 1A-B, learning system 104 receives patient information from one or more of EHR 101, ECG 102, and additional datastores 103. As set out above, in some embodiments, the learning system comprises a convolutional neural network. In various embodiments, the input to the convolutional neural network comprises voltage-time information an ECG, which in some embodiments is paired with additional patient information such as demographics or genetic information.

With continued reference to FIGS. 1A-B, learning system 104 may be pretrained using suitable population data as set out in the examples in order to produce an indication of the level of CAC. In some embodiments, the indication is binary. In some embodiments, the indication is a probability value, indicating the likelihood of the level of CAC given the input patient data. For the purposes of this disclosure, an “indication of a level of CAC” is an output corresponding to coronary artery calcium burden of a subject. In some cases, indication of the level of CAC may include a score, value, class, threshold result, probability, or other representation associated with a quantity or severity of coronary artery calcium.

With continued reference to FIGS. 1A-B, learning system 104 provides the indication of the level of CAC for storage as part of an EHR. In this way, a computer-aided diagnosis is provided, which may be referred to by a clinician. In some embodiments, learning system 104 provides the indication of the level of CAC to a remote client 105. For example, a remote client may be a health app, a cloud service, or another consumer of diagnostic data. In some embodiments, the learning system 104 is integrated into an ECG machine for immediate feedback to a user during testing.

With continued reference to FIGS. 1A-B, a feature vector is provided to a learning system. Based on the input features, the learning system generates one or more outputs. In some embodiments, the output of the learning system is a feature vector. The feature vector can contain a time-series of values indicating an amplitude of the voltage-time data for the plurality of leads.

With continued reference to FIGS. 1A-B, the learning system comprises an SVM. In other embodiments, the learning system comprises an artificial neural network. In some embodiments, the learning system is pre-trained using training data. In some embodiments training data is retrospective data. In some embodiments, the retrospective data is stored in a data store. In some embodiments, the learning system may be additionally trained through manual curation of previously generated outputs.

With continued reference to FIGS. 1A-B, the learning system, is a trained classifier. In some embodiments, the trained classifier is a random decision forest. However, it will be appreciated that a variety of other classifiers are suitable for use according to the present disclosure, including linear classifiers, support vector machines (SVM), or neural networks such as recurrent neural networks (RNN).

With continued reference to FIGS. 1A-B, suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

With continued reference to FIGS. 1A-B, a convolutional neural network (CNN) is a class of feed-forward artificial neural networks applicable to analyzing visual imagery and other natural signals. A CNN consists of an input and an output layer, as well as multiple hidden layers. The hidden layers of a CNN typically consist of convolutional layers, pooling layers, fully connected layers, and normalization layers. Convolutional layers apply a convolution operation to the input, passing the result to the next layer. The convolution emulates the response of an individual neuron to stimuli. Each convolutional neuron processes data only for its receptive field.

With continued reference to FIGS. 1A-B, a convolution operation allows a reduction in free parameters as compared to a fully connected feed forward network. In particular, tiling a given kernel allows a fixed number of parameters to be learned irrespective of image size. This likewise reduces the memory footprint for a given network.

With continued reference to FIGS. 1A-B, a convolutional layer's parameters consist of a set of learnable filters (or kernels), which have a small receptive field, but extend through the full depth of the input volume. During the forward pass, each filter is convolved across the width and height of the input volume, computing the dot product between the entries of the filter and the input, and producing a 2-dimensional activation map of that filter. As a result, the network learns filters that activate when it detects some specific type of feature at some spatial position in the input.

With continued reference to FIGS. 1A-B, a kernel comprises a plurality of weights w₁ . . . w₉. It will be appreciated that the sizes provided here are merely exemplary, and that any kernel dimension may be used as described herein. The kernel is applied to each tile of an input (e.g., an image). The result of each tile is an element of a feature map. It will be appreciated that if a plurality of kernels may be applied to the same input in order to generate multiple feature maps.

With continued reference to FIGS. 1A-B, stacking the feature maps for all kernels forms a full output volume of the convolution layer. Every entry in the output volume can thus also be interpreted as an output of a neuron that looks at a small region in the input and shares parameters with neurons in the same feature map.

With continued reference to FIGS. 1A-B, convolutional neural networks may be implemented in various hardware, including hardware CNN accelerators and GPUs.

With continued reference to FIGS. 1A-B, in FIG. 1B, a schematic view of an exemplary embodiment of a system for detecting or otherwise predicting coronary artery calcium (CAC) and cardiovascular risk is illustrated. A system for electrocardiographic prediction of computed tomography-based high coronary calcium score includes at least a processor and a computer readable storage medium communicatively connected to the at least a processor. The computer readable storage medium contains instructions configuring the at least a processor to receive voltage-time data of a subject, wherein the voltage-time data includes voltage data from a plurality of leads of an electrocardiogram ECG 102. The at least a processor generates a feature vector as a function of the voltage-time data, wherein the feature vector includes one or more time-series of values indicating an amplitude of an electrocardiogram for the plurality of leads. The at least a processor further processes the feature vector using a trained learning system 104 comprising one or more CNNs that includes a first convolutional neural network first CNN 106 to generate one or more CNN outputs including an indication of a level of coronary artery calcium associated with the subject. The at least a processor then determines an indication of cardiovascular risk indication of cardiovascular risk 107 for the subject based on the one or more CNN outputs, wherein the CNN outputs includes indication of the level of coronary artery calcium, wherein indication of cardiovascular risk 107 corresponds to a likelihood of the subject having or developing a cardiovascular condition within a future time interval. For the purposes of this disclosure, a “cardiovascular condition” is a disease state, pathological state, abnormality, or clinically relevant cardiovascular status associated with a heart or vasculature. In some cases, cardiovascular condition may include disease state, pathological state, abnormality, or clinically relevant cardiovascular status associated with a heart or vasculature including atherosclerotic cardiovascular disease, coronary artery disease, myocardial infarction, ischemic stroke, coronary calcium burden, regional wall motion abnormality, or death due to a cardiovascular event.

With continued reference to FIGS. 1A-B, for the purposes of this disclosure, a “future time interval” is a period of time extending forward from a reference point associated with a subject. In some cases, reference point may include an index electrocardiogram, an evaluation date, a processing time, a diagnosis time, or another selected baseline point in time, and wherein the period of time is used to define a predictive horizon for assessing a likelihood of occurrence of a cardiovascular condition or cardiovascular event. In some embodiments, the future time interval may include at least one day, one week, one month, six months, one year, three years, five years, ten years, another prospective duration, or combinations thereof in some embodiments, indication of cardiovascular risk 107 may correspond to a likelihood of a cardiovascular condition or cardiovascular event occurring within a future time interval measured from an index ECG, a baseline clinical encounter, or another reference point associated with the subject. In some embodiments, the future time interval may define a predictive horizon over which learning system 104 evaluates whether a subject may experience a major adverse cardiovascular event, an atherosclerotic cardiovascular disease event, progression of coronary calcium burden, or another cardiovascular outcome. In some embodiments, the future time interval may be predetermined, selected by a clinician, selected by remote client 105, determined based on one or more characteristics of the subject, or determined based on one or more operating parameters of learning system 104. In some embodiments, the future time interval may include one year, three years, five years, ten years, or another prospective duration, such that indication of cardiovascular risk 107 may reflect longer-term cardiovascular-risk protection and may distinguish between subjects having different event rates, different times to event, or both over the selected predictive horizon.

With continued reference to FIGS. 1A-B, the voltage-time data may be received directly from ECG 102, from an electronic health record EHR 101, from one or more datastores datastore 103, or from combinations thereof. For the purposes of this disclosure, “voltage-time data” is data characterizing electrical activity of a heart over time and across the plurality of leads. In some cases, voltage-time data may include raw waveform samples, processed waveform samples, stored digital ECG data, normalized ECG data, filtered ECG data, segmented ECG data, or combinations thereof. In some embodiments, learning system 104 may receive the voltage-time data from ECG 102 in near real time. In some embodiments, learning system 104 may receive the voltage-time data from EHR 101 or datastore 103 for retrospective or deferred analysis. In some embodiments, the voltage-time data may be represented as a multi-lead digital ECG waveform corresponding to a standard 12-lead electrocardiogram.

With continued reference to FIGS. 1A-B, the feature vector may include a matrix, tensor, latent representation, or other structured representation derived from the voltage-time data. In some embodiments, the feature vector includes one or more rows corresponding to time and one or more columns corresponding to lead position, spatial arrangement, or another ECG dimension. In some embodiments, the feature vector may be formed from raw ECG waveform values. In some embodiments, the feature vector may be formed from transformed waveform data, beat-aligned waveform segments, averaged beats, median beats, spectrogram representations, grouped lead subsets, or combinations thereof. In some embodiments, the feature vector may be configured to preserve amplitude information across the plurality of leads such that first CNN 106 can process inter-lead and temporal relationships in the electrocardiogram.

With continued reference to FIGS. 1A-B, first CNN 106 may process the feature vector to generate a first CNN output 108 corresponding to the indication of the level of coronary artery calcium associated with the subject. For the purposes of this disclosure, “first CNN output” is an output of first CNN 106. In some cases, first CNN output 108 may correspond to a CAC-related result. In some cases, first CNN output 108 may include a score, probability, class label, binary indicator, thresholded output, multi-class output, or another representation of coronary artery calcium burden. In some embodiments, first CNN 106 may be trained using ECG data correlated to CAC labels, CAC values, CAC thresholds, or CAC classifications. In some embodiments, the indication of the level of coronary artery calcium may be derived directly from first CNN output 108. In some embodiments, the indication of the level of coronary artery calcium may be derived by post-processing first CNN output 108.

With continued reference to FIGS. 1A-B, indication of cardiovascular risk 107 may be determined based on the indication of the level of coronary artery calcium. For the purposes of this disclosure, “indication of cardiovascular risk” is an output corresponding to a likelihood of the subject having or developing a cardiovascular condition. In some embodiments, the cardiovascular condition may include atherosclerotic cardiovascular disease, coronary artery disease, myocardial infarction, ischemic stroke, death due to a cardiovascular event, or another cardiovascular condition associated with coronary artery calcium burden. In some embodiments, indication of cardiovascular risk 107 may be generated by mapping the indication of the level of coronary artery calcium to a cardiovascular risk score, a cardiovascular risk class, a threshold likelihood, a categorical risk output, or another cardiovascular-risk-associated output. In some embodiments, indication of cardiovascular risk 107 may be stored in EHR 101, stored in datastore 103, transmitted to remote client 105, displayed to a user, or combinations thereof.

With continued reference to FIGS. 1A-B, in some embodiments, the system may receive demographic data associated with the subject, and the feature vector may be generated as a function of the demographic data and the voltage-time data. The demographic data may be received from EHR 101, datastore 103, remote client 105, or another suitable source. In some embodiments, the demographic data may include age, sex, race, ethnicity, body mass index, smoking-status information, blood-pressure-related data, family-history information, other demographic or clinical information associated with cardiovascular risk, or combinations thereof. The demographic data may be concatenated with waveform-derived features, encoded into one or more additional channels, embedded into a latent representation, appended to one or more fully connected layers, or otherwise combined with the voltage-time data to generate the feature vector. For the purposes of this disclosure, “demographic data” is data characterizing one or more demographic or population-associated attributes of a subject. In some cases, demographic data may include age, sex, race, ethnicity, body mass index, smoking status, family-history information, or other subject-level information associated with cardiovascular-risk stratification.

With continued reference to FIGS. 1A-B, in some embodiments, the system may further receive genomic data associated with the subject, and the feature vector may be generated as a function of the genomic data and the voltage-time data. The genomic data may be received from EHR 101, datastore 103, a laboratory information system, or another data source. In some embodiments, the genomic data may include one or more genetic markers, genomic risk features, biomarker-derived genomic indicators, inherited predisposition indicators, or combinations thereof associated with coronary disease, calcium burden, cardiovascular-event propensity, or the like. The genomic data may be combined with the voltage-time data in a manner similar to the demographic data such that learning system 104 may process an integrated feature representation incorporating waveform information and genomic information. For the purposes of this disclosure, “genomic data” is data characterizing one or more inherited, genetic, molecular, or biomarker-associated attributes of a subject. In some cases, genomic data may include one or more genetic markers, genomic-risk features, inherited predisposition indicators, or other sequence-based or genotype-associated information.

With continued reference to FIGS. 1A-B, in some embodiments, receiving the voltage-time data of the subject may include receiving the voltage-time data from EHR 101. EHR 101 may store previously acquired digital ECG waveform data, patient identifiers, examination dates, waveform metadata, risk-associated clinical fields, or other information useful for generating the feature vector and operating learning system 104. In some embodiments, EHR 101 may supply both the voltage-time data and accompanying demographic data, genomic data, or both to learning system 104. Receiving the voltage-time data from EHR 101 may permit retrospective analysis of a subject's ECG without reacquiring the ECG from ECG 102.

With continued reference to FIGS. 1A-B, in some embodiments, the system may further determine a treatment plan for the subject in response to the indication of the level of CAC. The treatment plan may include recommending additional diagnostic workup, obtaining further cardiovascular imaging, obtaining laboratory testing, initiating or intensifying lipid-lowering therapy, initiating or intensifying antihypertensive therapy, recommending lifestyle interventions, scheduling follow-up monitoring, referring the subject to a specialist, or combinations thereof. In some embodiments, the treatment plan may be determined in response to the indication of the level of CAC alone. In some embodiments, the treatment plan may be determined in response to both the indication of the level of CAC and indication of cardiovascular risk 107. The treatment plan may be transmitted to remote client 105, stored in EHR 101, or output to a clinician-facing interface. For the purposes of this disclosure, a “treatment plan” is a set of one or more clinically actionable measures determined for a subject in response to an output of the disclosed system. In some cases, the clinically actionable measures may include diagnostic evaluation, monitoring, referral, medication initiation, medication modification, preventive intervention, lifestyle intervention, or combinations thereof.

With continued reference to FIGS. 1A-B, in some embodiments, learning system 104 may further include a second convolutional neural network (CNN) 109 configured to process the voltage-time data to generate an indication of a regional wall motion abnormality associated with the subject. In some embodiments, second CNN 109 may process the voltage-time data directly. In some embodiments, second CNN 109 may process the feature vector or a second feature representation derived from the voltage-time data. In some embodiments, second CNN 109 may be trained using ECG waveform data correlated to labels indicative of regional wall motion abnormality, ventricular dysfunction, myocardial injury, ischemic burden, or combinations thereof. Second CNN 109 may generate a second CNN output 110 that may correspond to a presence, absence, severity, distribution, or likelihood of regional wall motion abnormality. For the purposes of this disclosure, “second CNN output” is an output of second CNN 109. In some cases, second CNN output 110 may correspond to a wall-motion-abnormality-related result. In some cases, second CNN output 110 may include a score, probability, class label, thresholded output, encoded latent representation, or the like. For the purposes of this disclosure, a “regional wall motion abnormality” is an abnormality in motion of a localized portion of cardiac muscle during a cardiac cycle. In some cases, the abnormality may include hypokinesis, akinesis, dyskinesis, asynchronous motion, or another deviation from expected myocardial wall movement.

With continued reference to FIGS. 1A-B, in some embodiments, determining indication of cardiovascular risk 107 may include determining indication of cardiovascular risk 107 as a function of both the indication of the level of coronary artery calcium and the indication of the regional wall motion abnormality. For example, and without limitation, first CNN output 108 and second CNN output 110 may be fused, combined, weighted, concatenated, ensembled, or otherwise jointly processed to determine indication of cardiovascular risk 107. In some embodiments, first CNN output 108 may correspond to calcium-burden-related information and second CNN output 110 may correspond to cardiac-functional-abnormality-related information, and learning system 104 may combine both outputs to identify subjects having a heightened risk of a cardiovascular condition. In some embodiments, the combined use of first CNN output 108 and second CNN output 110 may improve prediction of future cardiovascular events relative to use of first CNN output 108 alone.

With continued reference to FIGS. 1A-B, in some embodiments, indication of cardiovascular risk 107 may include a ternary classification comprising no additional risk identified, increased risk, and substantially increased risk. The no additional risk identified classification may correspond to a subject for whom the system does not identify a heightened cardiovascular risk beyond a baseline or otherwise expected risk level. The increased risk classification may correspond to a subject having a higher rate of atherosclerotic cardiovascular disease (ASCVD) events. The substantially increased risk classification may correspond to a subject having a higher rate of ASCVD events and a shorter time to an ASCVD event. In some embodiments, these classifications may be determined using one or more thresholds applied to first CNN output 108, second CNN output 110, indication of cardiovascular risk 107, or combinations thereof. For the purposes of this disclosure, a “ternary classification” is a classification output having three distinct categories. In some cases, each category may correspond to a different level, state, or significance of risk or condition.

With continued reference to FIGS. 1A-B, in some embodiments, the increased risk classification may indicate that the subject has a higher rate of ASCVD events relative to subjects classified as having no additional risk identified. In some embodiments, the substantially increased risk classification may indicate that the subject has both a higher rate of ASCVD events and a shorter time to an ASCVD event relative to subjects classified as having increased risk or no additional risk identified. The ASCVD events may include myocardial infarction, ischemic stroke, death due to a cardiovascular event, or combinations thereof. In some embodiments, the ternary classification provided by indication of cardiovascular risk 107 may be used to stratify subjects into distinct clinical pathways, monitoring categories, prevention categories, or the like.

With continued reference to FIGS. 1A-B, in some embodiments, indication of cardiovascular risk 107 may correspond to a likelihood of a major adverse cardiovascular event (MACE) occurring within a future time interval. The future time interval may include one year, three years, five years, ten years, another prospective interval, or combinations thereof. In some embodiments, the MACE may include at least one of acute myocardial infarction, acute ischemic stroke, and death due to the acute myocardial infarction or the acute ischemic stroke. Learning system 104 may be configured to generate indication of cardiovascular risk 107 in a manner that may distinguish subjects having a higher event rate, a shorter time to event, or both. Accordingly, indication of cardiovascular risk 107 may be usable to identify populations having higher rates of cardiovascular events, shorter times to cardiovascular events, or both, even when derived from ECG waveform data obtained from ECG 102, EHR 101, or both. For the purposes of this disclosure, a “likelihood of a MACE” is a predictive representation corresponding to a chance of occurrence of a major adverse cardiovascular event within a defined interval. In some cases, the major adverse cardiovascular event may include at least one of acute myocardial infarction, acute ischemic stroke, and death due to the acute myocardial infarction or the acute ischemic stroke.

With continued reference to FIGS. 1A-B, remote client 105 may include a clinician workstation, a server application, a cloud service, a mobile computing device, a healthcare software platform, or another external computing node configured to receive the indication of the level of coronary artery calcium, first CNN output 108, second CNN output 110, indication of cardiovascular risk 107, treatment-plan information, or combinations thereof. In some embodiments, remote client 105 may present a clinician-facing display including the CAC-related output, the regional-wall-motion-abnormality-related output, and the corresponding cardiovascular-risk output. In some embodiments, remote client 105 may further permit storage, review, confirmation, escalation, or transmission of one or more outputs generated by learning system 104.

With continued reference to FIGS. 1A-B, in some embodiments, first CNN 106 and second CNN 109 may be trained using retrospective and/or prospective training data obtained from one or more cardiovascular cohort studies, clinical repositories, EHR 101 systems, datastore 103 resources, or combinations thereof. In some cases, the training data may include digital 12-lead ECG waveform data acquired from a plurality of subjects and corresponding reference labels associated with each subject. In some embodiments, the training data for first CNN 106 may include ECG data paired with coronary artery calcium information, such as CAC score, CAC class, elevated CAC status, or another indication of coronary calcium burden derived from computed tomography or another reference assessment. In some cases, the training data for second CNN 109 may include ECG data paired with labels indicative of regional wall motion abnormality derived from cardiac imaging, clinical interpretation, structured report data, or combinations thereof. In some embodiments, the training data may further include subject-specific demographic data, genomic data, clinical risk-factor data, follow-up cardiovascular-outcome data, or combinations thereof, such that learning system 104 may be trained, validated, calibrated, or otherwise configured using data collected across diverse populations, including community-based cohorts having longitudinal follow-up and repeated ECG acquisitions over time.

With continued reference to FIGS. 1A-B, in some embodiments, learning system 104 may include one or more convolutional neural networks (CNNs) configured to process a feature vector derived from voltage-time data of a subject to generate one or more CNN outputs associated with the subject. For the purposes of this disclosure, “CNN outputs” are model-generated outputs using one or more CNNs. In some cases, CNN outputs may include one or more scores, probabilities, classifications, latent representations, thresholded outputs, or other model-generated outputs corresponding to one or more coronary-disease-related states, conditions, or risks of the subject. In some embodiments, the one or more CNN outputs may correspond to coronary artery calcium burden, obstructive coronary artery disease, regional wall motion abnormality, prior myocardial infarction, acute coronary event risk, mortality risk, another coronary-disease-related condition, or combinations thereof. In some embodiments, learning system 104 may include a first CNN 106 configured to generate an indication of a level of coronary artery calcium, wherein first CNN 106 may generate a first CNN output 108 corresponding to a computed-tomography-correlated calcium burden, a CAC threshold, a CAC class, a CAC score category, or another calcium-related output.

With continued reference to FIGS. 1A-B, in some embodiments, learning system 104 may further include one or more additional CNNs configured to identify different disease states or stages along a coronary disease spectrum. For example, learning system 104 may include a second convolutional neural network second CNN 109 configured to generate an output corresponding to obstructive coronary artery disease, severe coronary stenosis, regional left ventricular akinesis, regional wall motion abnormality, evidence of possible prior myocardial infarction, or combinations thereof. In some embodiments, second CNN 109 may generate a second CNN output 110 corresponding to one or more such disease states. In some embodiments, each CNN may be trained using reference labels associated with a specific disease state, such that learning system 104 may preserve disease-specific pathophysiologic sensitivity while still permitting broader cardiovascular-risk assessment. In some embodiments, the one or more CNNs may therefore target coronary disease across a spectrum from subclinical atherosclerotic burden to obstructive disease to infarction-associated abnormalities.

With continued reference to FIGS. 1A-B, in some embodiments, indication of cardiovascular risk 107 may be determined as a function of the one or more CNN outputs. In some embodiments, first CNN output 108 corresponding to coronary artery calcium and second CNN output 110 corresponding to another coronary-disease-related condition may be combined, ensembled, weighted, concatenated, aggregated, thresholded, or otherwise jointly processed to determine indication of cardiovascular risk 107. In some embodiments, indication of cardiovascular risk 107 may correspond to a likelihood of the subject having or developing a cardiovascular condition within a future time interval. In some embodiments, the future time interval may include one year, three years, five years, ten years, another prospective interval, or combinations thereof. In some embodiments, indication of cardiovascular risk 107 may correspond to a likelihood of acute coronary event occurrence, major adverse cardiovascular event occurrence, mortality, or another cardiovascular outcome within the future time interval.

With continued reference to FIGS. 1A-B, in some embodiments, the use of multiple CNNs within learning system 104 may permit broader and more accurate risk reclassification than a single-model architecture by combining outputs associated with multiple points along the coronary disease continuum. In some embodiments, a subject having a positive first CNN output 108 may be identified as having a first level of cardiovascular risk, whereas a subject having positive results on both first CNN output 108 and second CNN output 110 may be identified as having a higher level of cardiovascular risk, a shorter time to event, or both. In some embodiments, the disclosed architecture may therefore provide a technical framework for electrocardiographic prediction of cardiovascular risk using readily obtainable ECG data while capturing latent waveform patterns associated with multiple coronary-disease-related conditions that may not be evident from conventional ECG interpretation alone. The resulting indication of cardiovascular risk 107 may be stored in EHR 101, stored in datastore 103, transmitted to remote client 105, displayed to a clinician, or used to support subsequent diagnostic or preventive intervention.

With continued reference to FIGS. 1A-B, in some embodiments, learning system 104 may be developed or validated using a deidentified database derived from electronic health records associated with a large patient population distributed across multiple hospitals, clinics, health systems, geographic regions, or combinations thereof. In some embodiments, the database may include subjects having at least one digital 10-second, 12-lead ECG on record and may further include structured data, unstructured data, imaging-derived data, procedural data, laboratory data, diagnosis data, mortality data, or combinations thereof. In some embodiments, the deidentified database may be generated using a platform configured to convert raw EHR data into an anonymized and at least partially structured dataset suitable for model development, retrospective analysis, or both.

With continued reference to FIGS. 1A-B, in some embodiments, one or more disease-specific cohorts may be defined for training or evaluating one or more CNNs within learning system 104. For example, a CAC cohort may include subjects having an ECG within a selected time period of a coronary computed tomography scan and a corresponding CAC score, wherein disease cases may include subjects having elevated CAC and controls may include subjects having no observed coronary calcium and no acute coronary syndrome within a follow-up period. In some embodiments, an obstructive coronary artery disease cohort may include subjects having angiography, coronary CT angiography, bypass surgery, percutaneous coronary intervention, or combinations thereof, with disease and control definitions based on presence or absence of severe stenosis or minimal stenosis. In some embodiments, a regional left ventricular akinesis cohort may include subjects having echocardiographic assessment of regional wall motion abnormalities and a temporally associated ECG, wherein disease and control cohorts may be separated based on whether one or more akinetic segments are present.

With continued reference to FIGS. 1A-B, in some embodiments, model development may include training separate convolutional neural networks for distinct disease targets, including CAC, obstructive coronary artery disease, and regional left ventricular akinesis. In some embodiments, cohort datasets may be split at the patient level into training, validation, and testing datasets so that ECGs from a given patient are assigned to only one dataset. In some embodiments, the input to each CNN may include a 10-second ECG signal having 12 leads, each lead including a plurality of samples acquired at a predetermined sampling frequency, such as 500 Hz. In some embodiments, each CNN may include an input layer, a plurality of convolutional blocks, one or more pooling layers, one or more fully connected layers, and an output layer configured to generate output probabilities, classifications, or scores. In some embodiments, model training may further use pretrained weights derived from a self-supervised ECG representation model trained on a large corpus of ECG data.

With continued reference to FIGS. 1A-B, in some embodiments, indication of cardiovascular risk 107 may be determined using first CNN output 108, second CNN output 110, or both, in conjunction with risk estimation data derived from subject-level clinical information. In some embodiments, a ten-year ASCVD risk score may be computed at a time of ECG acquisition using clinical variables including lipid values, blood pressure data, smoking information, diagnosis data, race or ethnicity data, age, treatment status, or combinations thereof, wherein available structured data, unstructured data, or both may be used. In some embodiments, learning system 104 may be evaluated in cohorts of subjects having evidence of primary care and lacking known ASCVD at cohort entry, and event-survival analyses may be performed over multiple observation windows, including 3-year, 5-year, and 10-year periods. In some embodiments, an acute coronary event may be defined as a composite occurrence of acute coronary syndrome, coronary artery bypass grafting, or percutaneous coronary intervention, and subjects lost to follow-up may be censored at a last known encounter.

With continued reference to FIGS. 1A-B, in some embodiments, learning system 104 may be configured not only to generate disease-specific outputs, but also to support risk reclassification relative to conventional risk estimation frameworks. In some embodiments, subjects may be grouped according to conventional ASCVD risk categories and then further stratified based on one or more CNN outputs, such as first CNN output 108 and second CNN output 110. In some embodiments, clinical diagnoses, medication histories, laboratory results, or combinations thereof may be compared between subjects whose ECG-AI-based risk classification is higher than a conventionally estimated risk and subjects whose ECG-AI-based risk classification is lower than the conventionally estimated risk. Such comparisons may be used to identify co-morbidities, biomarkers, or clinical features associated with discordant risk classification and to further characterize clinical significance of the model outputs.

With continued reference to FIGS. 1A-B, in some embodiments, evaluation of learning system 104 may include patient-level performance assessment using a testing dataset and repeated sampling techniques to account for subjects contributing multiple ECGs. In some embodiments, receiver operating characteristic analysis, sensitivity, specificity, hazard modeling, effect size estimation, or combinations thereof may be used to assess performance of one or more CNNs and the resulting indication of cardiovascular risk 107. In some embodiments, survival analyses may be used to determine whether combinations of disease-specific CNN outputs identify subjects having sequentially greater rates of acute coronary events, mortality, or both across multiple future time intervals. Accordingly, the disclosed architecture may be used to identify additive risk across multiple disease states and time horizons, including timeframes shorter than a conventional 10-year risk framework.

With continued reference to FIGS. 1A-B, the disclosed system may permit receipt of ECG waveform data from ECG 102, EHR 101, datastore 103, or combinations thereof, generation of a feature vector representative of ECG amplitudes across a plurality of leads; processing of the feature vector by first CNN 106 to generate first CNN output 108 indicative of a level of CAC; optional processing by second CNN 109 to generate second CNN output 110 indicative of a regional wall motion abnormality; determination of indication of cardiovascular risk 107 for the subject; and output of results to EHR 101, datastore 103, remote client 105, or combinations thereof for storage, display, cardiovascular-risk stratification, and clinical action. In some embodiments, the present disclosure can address a technical problem associated with conventional cardiovascular-risk assessment systems, namely that existing approaches either rely on separate imaging modalities, such as computed-tomography-based CAC scoring, or depend on clinical risk calculators that may fail to capture latent electrocardiographic patterns associated with future cardiovascular events. This technical problem may result in increased cost, additional workflow burden, reduced accessibility, and incomplete risk stratification when only traditional inputs are used. The present disclosure solves this technical problem using a technical solution in which voltage-time data from a multi-lead ECG is transformed into a feature vector and processed by learning system 104, including first CNN 106 and, in some embodiments, second CNN 109, to derive first CNN output 108 associated with CAC and second CNN output 110 associated with regional wall motion abnormality, wherein indication of cardiovascular risk 107 is determined as a function of one or both outputs. By computationally extracting and combining waveform-derived features that are not readily identifiable through manual review, the disclosed architecture improves automated cardiovascular-risk stratification from standard ECG data, reduces dependence on separate imaging workflows, and enables a more scalable and technically integrated mechanism for identifying subjects having elevated event rates, shorter times to event, or both.

With continued reference to FIGS. 1A-B, in some embodiments, the present disclosure addresses a technical problem associated with conventional cardiovascular-risk assessment systems, namely that existing approaches either rely on separate imaging modalities, invasive testing, stress testing, or clinical risk calculators that may fail to detect latent electrocardiographic signatures associated with different stages of coronary disease and future cardiovascular events. This technical problem may result in incomplete risk stratification, delayed identification of high-risk subjects, reduced temporal resolution for event prediction, and increased dependence on workflows that are expensive, less accessible, or not routinely performed across broad patient populations. In particular, conventional approaches may inadequately capture disease manifestations distributed across a coronary-disease spectrum, including subclinical calcium burden, obstructive coronary disease, wall-motion-related evidence of possible prior infarction, and event-related risk that may not be apparent from standard ECG interpretation alone. The present disclosure solves this technical problem using a technical solution in which voltage-time data from a multi-lead ECG is transformed into a feature vector and processed by learning system 104, including first CNN 106 and, in some embodiments, second CNN 109 and one or more additional CNNs, to generate first CNN output 108, second CNN output 110, and other model outputs associated with different coronary-disease-related conditions. These outputs are then computationally combined to generate indication of cardiovascular risk 107, which may correspond to a likelihood of a cardiovascular condition or cardiovascular event within a future time interval. By using multiple trained CNNs to extract latent temporal, spatial, and inter-lead waveform patterns associated with different points along the coronary-disease continuum, the disclosed architecture improves technical detection of disease-specific and event-associated ECG features, enables additive or ensemble-based risk reclassification, and permits longer-horizon or serial assessment of cardiovascular risk using standard ECG data. As a result, the disclosure provides a more scalable, technically integrated, and computationally efficient mechanism for cardiovascular-risk prediction than conventional single-modality or manually interpreted approaches.

With continued reference to FIGS. 1A-B, in some embodiments, CNN-based learning system 104 may be used to provide longer-term cardiovascular-risk protection by processing voltage-time data from ECG 102, EHR 101, datastore 103, or combinations thereof to generate one or more outputs corresponding to a likelihood of a cardiovascular condition or cardiovascular event occurring within a future time interval. In some embodiments, first CNN 106 may extract latent temporal and inter-lead waveform patterns associated with coronary calcium burden, and second CNN 109 may extract waveform patterns associated with regional wall motion abnormality, such that first CNN output 108 and second CNN output 110 may be used individually or in combination to determine indication of cardiovascular risk 107 over one or more prospective horizons, including one year, three years, five years, ten years, or another future time interval. In some embodiments, learning system 104 may further be used for monitoring of risk over time by receiving first voltage-time data acquired at a first timepoint and second voltage-time data acquired at a later timepoint, comparing corresponding feature representations, CNN outputs, or risk outputs, and determining whether the subject's cardiovascular risk has increased, decreased, remained stable, crossed a threshold, or otherwise changed over time. In this manner, learning system 104 may provide a technical framework not only for one-time risk prediction, but also for serial reassessment of longer-term risk using repeated ECG-derived inputs obtained over time.

With continued reference to FIGS. 1A-B, in some embodiments, a system may be configured to perform using a diverse, multi-institutional database of cohort studies to assess efficacy of a SaMD designed to identify ASCVD risk via artificial-intelligence analysis of a 12-lead ECG. Suitable cohort studies may include Framingham Heart Study (FHS), Multi-Ethnic Study of Atherosclerosis (MESA), Cardiometabolic Risk Reduction in South Asia (CARRS), Atherosclerosis Risk in Communities (ARIC), Cardiovascular Health Study (CHS), Coronary Artery Risk Development in Young Adults (CARDIA), Jackson Heart Study (JHS), Women's Health Initiative (WHI), Hispanic Community Health Study/Study of Latinos (HCHS-SOL), combinations thereof, and other cardiovascular cohort studies. In some embodiments, eligible cohort studies may include participants from the general community, follow such participants over a period of about ten years or more, and phenotype such participants in a structured manner.

With continued reference to FIGS. 1A-B, in some embodiments, participants may have ECGs acquired at various timepoints during participation in a respective cohort study. Such ECG acquisitions may occur at fixed timepoints in conjunction with structured and comprehensive clinical assessments. A ten-year ASCVD risk may be computed at a time of each ECG using one or more ASCVD risk estimation equations and clinical data available at the time of ECG acquisition. In some embodiments, when a participant has an ASCVD event, the participant may be labeled as a case and a time of the ASCVD event relative to the ECG may be obtained from cohort study data.

With continued reference to FIGS. 1A-B, in some embodiments, the disclosed ASCVD ECG-AI SaMD (e.g., system and/or learning system 104) may be applied retrospectively or prospectively to ECG data (e.g., ECG 102) to identify three populations. A first population may include patients having higher rates of ASCVD events and shorter times to ASCVD event. A second population may include patients having higher rates of ASCVD events. A third population may include patients for whom no additional risk is identified. In some embodiments, the classification is ternary.

With continued reference to FIGS. 1A-B, in some embodiments, an input to the device comprises a 12-lead, about 10-second digital ECG waveform, although longer ECG waveform digital samples may be used. In some embodiments, information regarding hardware and software used to capture, process, and store the 12-lead ECG data may be collected for each input ECG. A statistical analysis plan may be used to analyze performance of a given version of the device.

With continued reference to FIGS. 1A-B, in some embodiments, a primary endpoint may include a time to first occurrence of a three-point major adverse cardiovascular event (MACE). The three-point MACE may be defined as acute myocardial infarction, acute ischemic stroke, or death due to such events, through a period of up to about ten years from an index ECG. In some embodiments, the endpoint is used to assess comparative risk of MACE occurrence and mean time free from MACE occurrence restricted to a ten-year time frame. In some embodiments, secondary outcomes may include incidence ratios, restricted mean survival time (RMST), event rates, c-statistics among groups, or combinations thereof. Such groups may include ECG-AI classes and clinical risk score strata. In some embodiments, primary and secondary endpoints may additionally be evaluated at one-year, three-year, and five-year timepoints. In some embodiments, supportive analyses may include evaluation using other definitions of cardiovascular events and coronary events, including definitions consistent with one or more risk scores.

With continued reference to FIGS. 1A-B, in some embodiments, the disclosed device may be intended to aid identification of ASCVD risk in adults beyond what traditional clinical risk factors indicate. In some embodiments, the device is not configured as a stand-alone diagnostic device for ASCVD and is not intended to replace existing clinical practice guidelines. Rather, the device may complement such guidelines by further stratifying risk or identifying subclinical disease.

With continued reference to FIGS. 1A-B, in some embodiments, a study population may be selected to be a diverse multicenter population representative of a general population, including participants from urban, metropolitan, suburban, and rural areas. The study population may include a racial and ethnic mixture representative of a target population. In some embodiments, subjects selected for evaluation satisfy inclusion criteria comprising participation in one or more specified cohort studies and availability of a digital 12-lead ECG for at least one examination during cohort participation. In some embodiments, subjects may be excluded where commercial-use research authorization is absent, where ASCVD is known at a time of ECG analysis, or where follow-up data are insufficient to adjudicate an event or non-event at one-year, three-year, five-year, or ten-year timepoints following an index ECG.

With continued reference to FIGS. 1A-B, in some embodiments, a primary objective may include determining efficacy, including risk ratio and restricted mean freedom from MACE, of the ASCVD ECG-AI SaMD for identifying ASCVD risk in pooled or individual diverse cardiovascular cohort studies relative to an unstratified cohort study population. In some embodiments, a secondary objective comprises assessing performance of the ASCVD ECG-AI SaMD for identifying a population of patients having a shorter time to ASCVD events than the unstratified cohort study population. In some embodiments, exploratory objectives comprise assessing efficacy of the ASCVD ECG-AI SaMD in populations stratified by ASCVD risk estimation equations, demographics, cohort study, ECG acquisition device characteristics, or combinations thereof.

With continued reference to FIGS. 1A-B, in some embodiments, servers may be provisioned within platforms that house digital clinical data and digital ECG waveforms. Analyses may be conducted on individual datasets and corresponding results may be pooled to generate final study results. In some embodiments, ECGs at an initial cohort study examination may be analyzed for all patients. ECGs at subsequent examinations may also be analyzed, although later examinations may have less follow-up time available for ten-year characterization. In some embodiments, later examinations may nonetheless be used for characterization of risk over shorter timeframes.

With continued reference to FIGS. 1A-B, in some embodiments, evaluation of additional risk identified beyond clinical risk scores includes computing ASCVD risk using multiple risk calculators, including pooled cohort equations (PCE), MESA score, Framingham Risk Score (FRS), Predicting Risk of cardiovascular EVENTs Score (PREVENT), or combinations thereof. At a time of each ECG, patients may be pre-stratified according to risk scores using categories comprising low risk, borderline risk, intermediate risk, and high risk. In some embodiments, low risk comprises less than about 5%, borderline risk comprises about 5% to less than about 7.5%, intermediate risk comprises about 7.5% to less than about 20%, and high risk comprises greater than or equal to about 20%. In some embodiments, evaluation of a primary endpoint includes assessing an ability of ECG-AI ASCVD to further stratify MACE risk over various timeframes. Because a definition of an event may differ among risk scores, the ability of ECG-AI ASCVD to further stratify risk may additionally be assessed using an event definition corresponding to a specific risk score used for pre-stratification.

With continued reference to FIGS. 1A-B, in some embodiments, deidentified and harmonized data may be securely transferred to a centralized repository for processing. Alternatively, patient-level data may remain stored on respective secure platforms. Once data is collected, a final locked device may be used to analyze ECG data for enrolled subjects without reference or access to interpretation data, diagnosis code data, or both. Results may be compared to a ground truth. Aggregate data from each cohort may be transferred to a central location for pooling and compiling a full set of study results.

With continued reference to FIGS. 1A-B, in some embodiments, a reference standard or ground truth for primary analysis may include first occurrence of a three-point MACE, defined as acute myocardial infarction, acute ischemic stroke, or death due to such events. In some embodiments, exploratory analyses may examine definitions of events aligned with one or more established risk scores. In some embodiments, events are defined as first occurrences of three-point MACE within a timeframe under analysis, and non-events are defined as patients that do not have a three-point MACE within the timeframe under analysis. In some embodiments, where stroke data are characterized as ischemic or hemorrhagic, only ischemic stroke events are included. In some embodiments, where stroke data are not further characterized by stroke type, all stroke events may be included in the analysis.

With continued reference to FIGS. 1A-B, in some embodiments, data collection and processing are performed in secure data environments associated with one or more cohort studies. For example, selected cohort study data may reside within a secure workspace of a National Institutes of Health (NIH) BioDataCatalyst (BDC) platform, a secure academic data environment, or another secure data environment. In some embodiments, where restrictions on international transfer of patient data apply, selected cohort data may remain within a secure workspace of a corresponding country or institution, and cohort-study-specific electronic case report forms may be generated locally.

With continued reference to FIGS. 1A-B, in some embodiments, raw cohort study data are version-controlled and publicly described. Static database generation code may be used to generate reproducible local study databases when applied to a same version of data used to generate original local study databases. Electronic case report forms may be combined into a local cohort study database. In some embodiments, database generation code used to create the local study database is locked prior to ECG-AI analysis. After ECG-AI analysis, ECG-AI results may be combined with the local study database to create a study-specific analysis dataset. Study-specific analysis datasets may then be transferred to a Data Coordinating Center (DCC) for pooled analysis. Analysis may be completed on a BDC platform, at a National Heart, Lung, and Blood Institute (NHLBI) environment, within a secure academic environment, or combinations thereof.

With continued reference to FIGS. 1A-B, in some embodiments, data harmonization may be performed using bulk data preparation and transfer coordinated by a study data management team. Each record may correspond to an electronic case report form. Investigators may be provided metadata guidelines to structure electronic data transfer. Study-specific analysis datasets may be extracted from participating cohort study databases and uploaded to a DCC. Uploaded data may be reviewed by a statistical team, and data clarifications may be communicated to investigators to resolve non-conformant data. Modifications to database harmonization code may be logged. Local cohort study data and a pooled final analysis dataset may be access-controlled.

With continued reference to FIGS. 1A-B, in some embodiments, conformant data may be combined into a single analysis dataset using reproducible research techniques. Downstream data processing may require that minor data changes, including renaming a variable, deriving categories to support analysis, or implementing inclusion or exclusion criteria, are traceable in programming code. In some embodiments, data for each cohort study are identified with a unique study identifier code to facilitate study-stratified analyses.

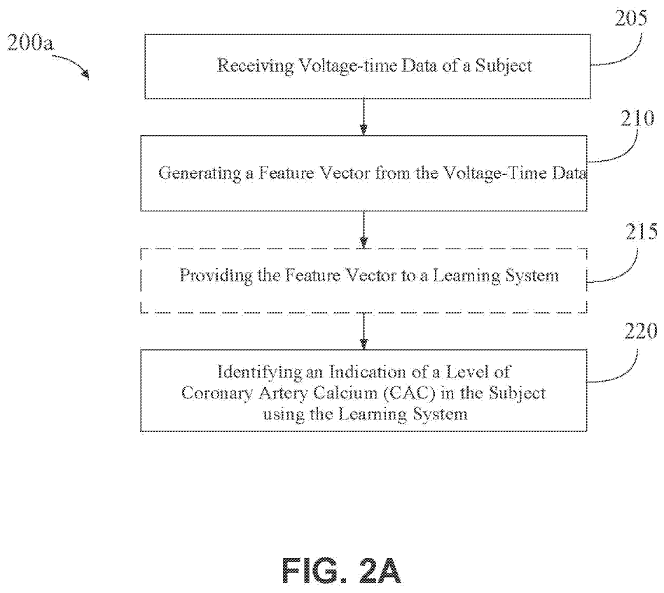

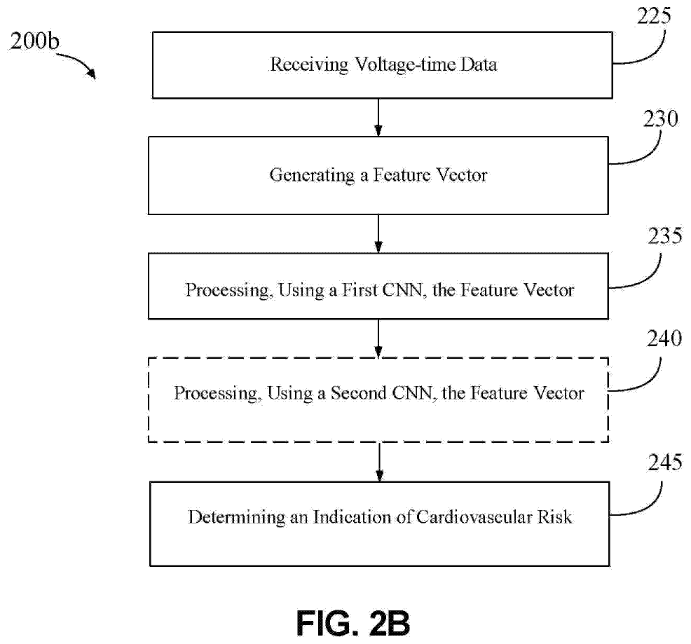

Referring now to FIG. 2A, a flowchart is provided illustrating a method 200a of detecting or otherwise predicting the level of CAC according to embodiments of the present disclosure.

With continued reference to FIG. 2A, at 205, the method 200a includes receiving, using at least a processor, voltage-time data of a subject, wherein the voltage-time data comprises voltage data from a plurality of leads of an electrocardiograph. The voltage-time data may include voltage data of a plurality of leads of an electrocardiograph. In an embodiment, the voltage-time data of a subject may be received from an electrocardiograph and/or an electronic medical record.

With continued reference to FIG. 2A, at 210, the method 200a includes generating, using the at least a processor, a feature vector as a function of the voltage-time data, wherein the feature vector comprises one or more time-series of values indicating an amplitude of the ECG for the plurality of leads. In an embodiment, the method may include generating the feature vector comprises generating a spectrogram based on the voltage data of the plurality of leads. In another embodiment, the method may include generating the feature vector by grouping the voltage data of the plurality of leads into a plurality of subsets. In an additional embodiment, the method may include receiving, using the at least a processor, demographic data and/or genomic data associated with the subject. The method may include generating, using the at least a processor, the feature vector as a function of the demographic data and/or genomic data and the voltage-time data. In a fourth embodiment, the feature vector may include a matrix, wherein the matrix may include a plurality of rows corresponding to a temporal dimension and a plurality of columns corresponding to a spatial dimension. In some cases, each row of the plurality of rows may correspond to at least one lead of the plurality of leads. In other cases, each column of the plurality of columns may correspond to at least one timestamp.

With continued reference to FIG. 2A, at 215, the method 200a may include providing the feature vector to a pretrained learning system.

With continued reference to FIG. 2A, at 220, the method 200a includes identifying, using the at least a processor, an indication of the level of coronary artery calcium (CAC) in the subject using a learning system.

Referring now to FIG. 2B, an exemplary flowchart illustrating a method 200b of detecting or otherwise predicting coronary artery calcium (CAC) and cardiovascular risk is illustrated. Method 200b contains a step 225 of receiving, using at least a processor, voltage-time data of a subject, wherein the voltage-time data includes voltage data from a plurality of leads. In some embodiments, the voltage-time data of the subject may be received from an electronic medical record. This may be implemented with reference to FIGS. 1A-B and without limitation.

With continued reference to FIG. 2B, method 200b contains a step 230 of generating, using the at least a processor, a feature vector as a function of the voltage-time data, wherein the feature vector includes one or more time-series of values indicating an amplitude of an electrocardiogram (ECG) for the plurality of leads. In some cases, method 200b may further include receiving, using the at least a processor, demographic data associated with the subject, and generating, using the at least a processor, the feature vector as a function of the demographic data and the voltage-time data. In some cases, method 200b may further include receiving, using the at least a processor, genomic data associated with the subject, and generating, using the at least a processor, the feature vector as a function of the genomic data and the voltage-time data. This may be implemented with reference to FIGS. 1A-B and without limitation.

With continued reference to FIG. 2B, method 200b contains a step 235 of processing, using the at least a processor and a trained learning system including one or more CNNs, the feature vector to generate one or more CNN outputs, wherein the one or more CNNs comprises a first CNN configured to generate an indication of a level of coronary artery calcium (CAC) associated with the subject. This may be implemented with reference to FIGS. 1A-B and without limitation.

With continued reference to FIG. 2B, method 200b may contain a step 240 of processing, using a second CNN of the trained learning system, the feature vector to generate an indication of a regional wall motion abnormality associated with the subject. This may be implemented with reference to FIGS. 1A-B and without limitation.

With continued reference to FIG. 2B, method 200b contains a step 245 of determining, using the at least a processor, an indication of cardiovascular risk for the subject as a function of the one or more CNN outputs, wherein the indication of cardiovascular risk corresponds to a likelihood of the subject having or developing a cardiovascular condition within a future time interval. In some embodiments, method 200b may further include determining, using the at least a processor, a treatment plan for the subject in response to the one or more CNN outputs. In some embodiments, determining the indication of cardiovascular risk may include determining the indication of cardiovascular risk as a function of the indication of the level of CAC and the indication of the regional wall motion abnormality. In some embodiments, the indication of cardiovascular risk may include a ternary classification including no additional risk identified, increased risk, and substantially increased risk. In some embodiments, the increased risk of the ternary classification may indicate that the subject has a higher rate of atherosclerotic cardiovascular disease (ASCVD) events, and the substantially increased risk of the ternary classification indicates that the subject has a higher rate of ASCVD events and a shorter time to an ASCVD event. In some embodiments, the indication of cardiovascular risk may correspond to a likelihood of a major adverse cardiovascular event (MACE) occurring within a future time interval, wherein the MACE may include at least one of acute myocardial infarction, acute ischemic stroke, and death due to the acute myocardial infarction or the acute ischemic stroke. This may be implemented with reference to FIGS. 1A-B and without limitation.

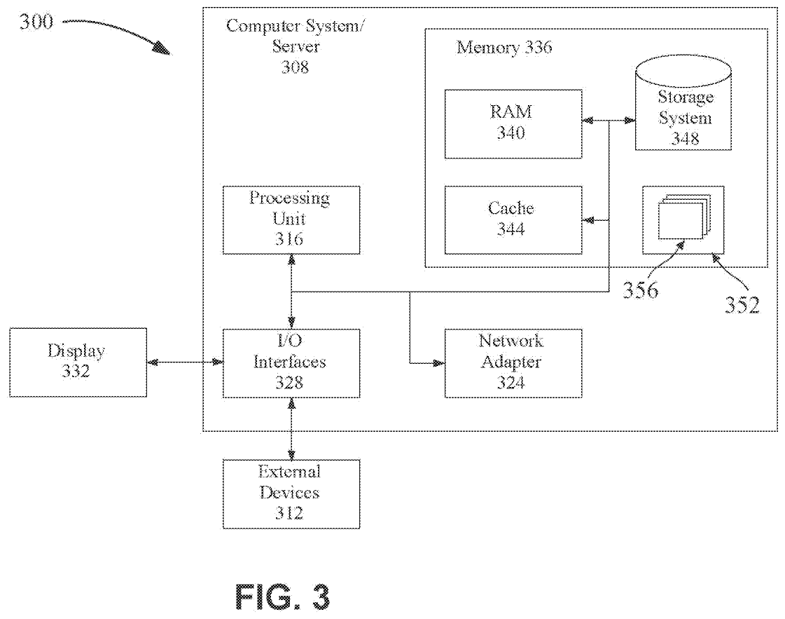

Referring now to FIG. 3, a schematic of an example of a computing node 300 is shown. Computing node 300 is only one example of a suitable computing node 300 and is not intended to suggest any limitation as to the scope of use or functionality of embodiments described herein. Regardless, computing node 300 is capable of being implemented and/or performing any of the functionality set forth hereinabove.

With continued reference to FIG. 3, in computing node 300 there is a computer system/server 308, which is operational with numerous other general purpose or special purpose computing system environments or configurations. Examples of well-known computing systems, environments, and/or configurations that may be suitable for use with computer system/server 308 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

With continued reference to FIG. 3, computer system/server 308 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 308 may be practiced in distributed cloud computing environments where tasks are performed by remote processing devices that are linked through a communications network. In a distributed cloud computing environment, program modules may be located in both local and remote computer system storage media including memory storage devices.

With continued reference to FIG. 3, computer system/server 308 in computing node 300 is shown in the form of a general-purpose computing device. The components of computer system/server 308 may include, but are not limited to, one or more processors or processing units 316, a system memory 336, and a bus that couples various system components including system memory 336 to processor 316.

With continued reference to FIG. 3, bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCie), and Advanced Microcontroller Bus Architecture (AMBA).

With continued reference to FIG. 3, computer system/server 308 typically includes a variety of computer system readable media. Such media may be any available media that is accessible by computer system/server 308, and it includes both volatile and non-volatile media, removable and non-removable media.

With continued reference to FIG. 3, system memory 336 can include computer system readable media in the form of volatile memory, such as random-access memory (RAM) 340 and/or cache memory 344. Computer system/server 308 may further include other removable/non-removable, volatile/non-volatile computer system storage media. By way of example only, storage system 348 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory 336 may include at least one program product having a set (e.g., at least one) of program modules that are configured to carry out the functions of embodiments of the disclosure.

With continued reference to FIG. 3, program/utility 352, having a set (at least one) of program modules 356, may be stored in memory 336 by way of example, and not limitation, as well as an operating system, one or more application programs, other program modules, and program data. Each of the operating system, one or more application programs, other program modules, and program data or some combination thereof, may include an implementation of a networking environment. Program modules 356 generally carry out the functions and/or methodologies of embodiments as described herein.

With continued reference to FIG. 3, computer system/server 308 may also communicate with one or more external devices 312 such as a keyboard, a pointing device, a display 332, etc.; one or more devices that enable a user to interact with computer system/server 308; and/or any devices (e.g., network card, modem, etc.) that enable computer system/server 308 to communicate with one or more other computing devices. Such communication can occur via Input/Output (I/O) interfaces 328. Still yet, computer system/server 308 can communicate with one or more networks such as a local area network (LAN), a general wide area network (WAN), and/or a public network (e.g., the Internet) via network adapter 324. As depicted, network adapter 324 communicates with the other components of computer system/server 308 via bus. It should be understood that although not shown, other hardware and/or software components could be used in conjunction with computer system/server 308. Examples include, but are not limited to microcode, device drivers, redundant processing units, external disk drive arrays, RAID systems, tape drives, and data archival storage systems, etc.

The present disclosure may be embodied as a system, a method, and/or a computer program product. For example, in some aspects or the invention, provided herein is a computer program product for detection and/or prediction of the level of CAC, the computer program product comprising a computer readable storage medium having program instructions embodied therewith, the program instructions executable by a processor to cause the processor to perform a method comprising: receiving voltage-time data of a subject from the echocardiograph, the voltage-time data comprising voltage data of the plurality of leads; generating a feature vector from the voltage-time data; providing the feature vector to a pretrained learning system; and receiving from the pretrained learning system an indication of the level of CAC in the subject. Generating the feature vector may comprise generating a spectrogram based on the voltage data of the plurality of leads. In some embodiments generating the feature vector comprises grouping the voltage data of the plurality of leads into a plurality of subsets.

In some embodiments, such computer program products further comprise receiving demographic information of the subject, wherein generating the feature vector comprises adding the demographic information to the feature vector. In some such embodiments, the computer program further comprises receiving genomic information of the subject. Generating the feature vector may comprise adding the genomic information to the feature vector. Without being bound by any particular methodology or theory, said genomic data may be derived from a biological sample that is derived from a patient predisposed to increased cardiovascular risk, e.g., family history or genetic and/or protein markers. In some such embodiments, the computer program product comprises a convolutional neural network. Such convolutional neural networks may comprise at least one residual connection.

In some embodiments the voltage-time data of a subject is received from an electrocardiograph. In further embodiments, the voltage-time data of a subject is received from an electronic medical record.

In some embodiments, the computer program product further comprises providing the indication to an electronic health record system for storage in a health record associated with the subject. In some embodiments, the computer program product further comprises providing the indication to a computing node for display to a user.

In some embodiments of the computer program product disclosed herein, the feature vector may comprise a matrix having a plurality of rows and a plurality of columns, the plurality of rows corresponding to a temporal dimension and the plurality of columns corresponding to a spatial dimension. In some such embodiments, each of the plurality of columns corresponds to one of the plurality of leads and each of the plurality of columns corresponds to a timestamp. In some embodiments, the temporal dimension has a resolution of 500 Hz. In some embodiments, the convolutional neural network comprises at least nine convolutional blocks and two fully connected blocks.

The computer program product provided herein may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program. products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

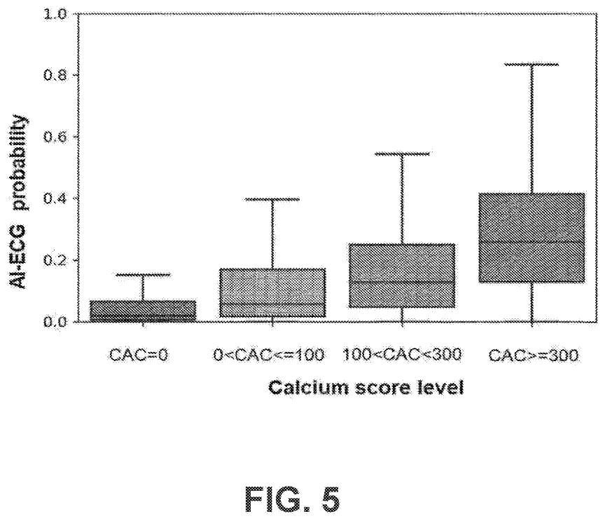

With reference to FIG. 5, a diagram of AI-ECG probability and calcium score level is shown.

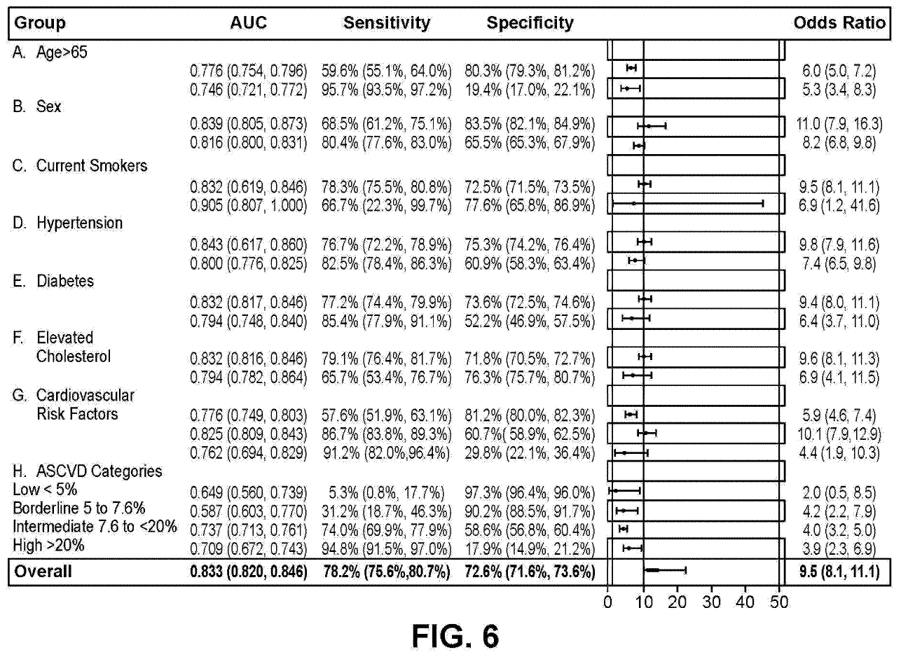

With reference to FIG. 6, a table showing network ROC, sensitivity, and specificity across subgroups is shown. Subgroups may include, as non-limiting examples, Age greater than or equal to 65, sex, smoking status, hypertension, diabetes, elevated cholesterol, cardiovascular risk factors, and ASCVD categories.

### EXAMPLES

### Example 1: Methods

A historical cohort of 43,210 consecutive patients that from the years 1997-2020 underwent clinically indicated CAC and ECG within 1 year was assessed. Major modifiable Cardiovascular (CV) risk factors were collected as part of preventive cardiology or general medical evaluation visits. The oldest CAC on record were used. Patients taking statins at the time of the CAC, with paced rhythm or with history of myocardial infarction or missing variables were excluded. A convolutional neural network based on ECG-AI output+/−CV risk factors to predict a high CAC score (2 300) on a random sample of 60%, and 20% of the dataset respectively was trained and validated. Model performance measures, using thresholds that yielded sensitivity of 90%, were evaluated in an independent testing set with the remaining 8,642 (20%) observations.

Definition and size of training and validation cohorts: The cohort consisted of 43,210 consecutive patients that from the years 1997-2020 underwent clinically indicated Computed tomography-based coronary artery calcium (CAC) scanning for cardiovascular risk stratification and clinically indicated electrocardiograms (ECG) within 1 year. A convolutional neural network based on ECG-AI output+/−CV risk factors to predict a high CAC score (2 300) on a random sample of 60%, and 20% of the dataset, respectively, was trained and validated. The association of the ECG-AI algorithms output was also validated to predict mortality in this cohort.

### Summary of Algorithm Architecture and Design:

CAC:
   Coronary artery calcium burden was quantified with CAC scoring of noncontract ECG-gated cardiac CT images.
   Continuous 3-mm-thick images were obtained using either electron beam or multi-slice CT scanners.
   Natural language processing (NLP) algorithms were used to extract the CAC score and percentiles from the radiologist narrative reports.
   NLP output achieved a prespecified threshold of 95% accuracy.
ECG:
   For training purposes, each ECG was converted to matrix of 12×5000, where the first dimension represents the spatial leads and the second time series of ten seconds at 500 Hz.
   A Convolutional Neural Network (CNN) based model was developed using the Kerns framework with TensorFlow (Google; Mountain View, CA, USA) implemented in Python.
   This framework has been previously successfully used for created validated models that screen for Left Ventricular disfunction and age and sex estimating from standard 12-lead ECG.
   The CNN was trained to generate binary classification models based on distinct levels of CAC (i.e., >0, 2:100, 2:300) with and without tabular data (i.e., clinical characteristics).
   This CNN consisted of stacked blocks of convolutional, max pooling, and batch normalization layers interspersed with ReLU activation functions and finalized with a fully connected layer.
   Models trained for 30 epochs with 0.001 learning rate and a batch size of 32. For models that also included tabular data the same hyper-parameters and CNN architecture were used.
   Then extracted ECG features from the last CNN layer were concatenated with tabular variables prior to the activation function in the final layer.
   Models were created using (i) ECG data only, (ii) ECG data in combination with age and sex (iii) ECG data, age, sex, and cardiovascular risk factors.

### Example 2: Results

### Performance of the Algorithm (AUC, Sensitivity, Specificity, PPVINPV, Etc.):

The ECG-AI age and sex algorithm's area under the receiving operating characteristics curve (ROC), sensitivity, specificity, and accuracy for CAC score 2: 300 was and 0.83, 0.90%, 0.56%, 0.60%.
The ECG-AI plus age and sex algorithm displayed equivalent performance when compared to the algorithm including ECG-Al, age, sex plus major modifiable CV risk factors (Delong's p-value>0.05).
Models performance was constant across subgroups, including those with no CV risk factors.
The ECG-AI algorithms output identified individuals at an approximate average two-fold risk of death over follow-up.
This association is:
   Independent of age, sex, traditional cardiovascular risk factors, current cardiovascular risk prediction algorithm, and importantly CT based CAC score+/−traditional risk factors.
   The output added value i.e., identified individuals at lower or higher risk of death within most current cardiovascular risk prediction algorithm and CT based CAC score categories.

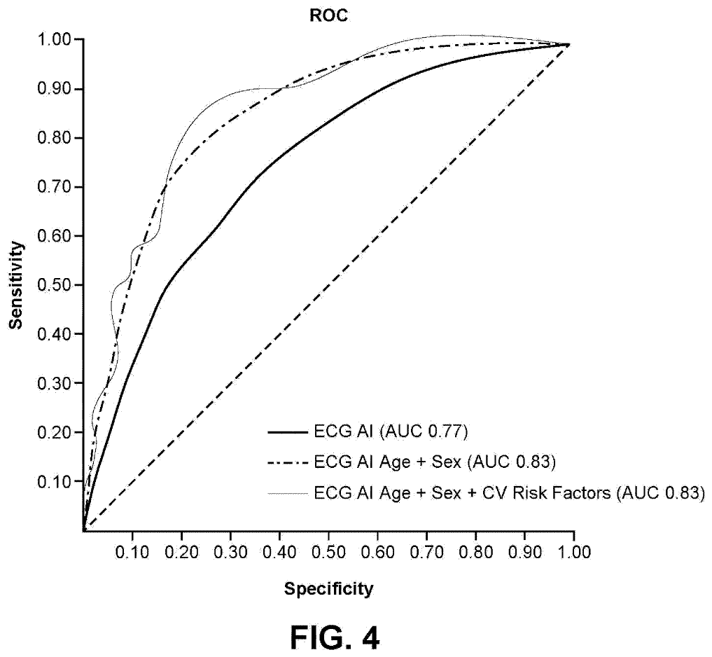

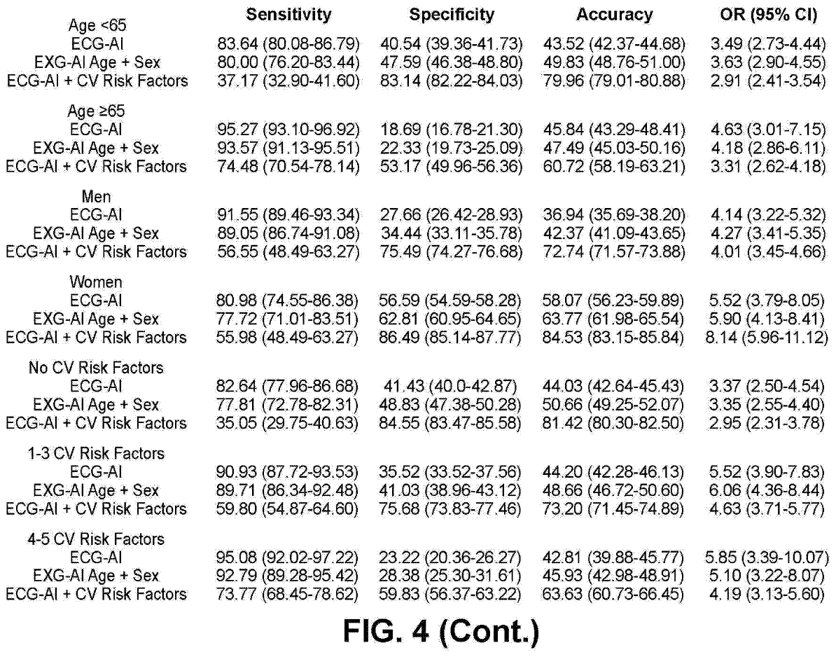

The ECG-AI plus age and sex algorithm displayed equivalent performance when compared to the algorithm including ECG-AI, age, sex plus major modifiable CV risk factors (see Table 1) (Delong's p-value>0.05). Models performance was constant across subgroups, including those with no CV risk factors, see FIG. 4.
Age 55±9.8
Sex, female 31%
1,857 (20%) Participants had CAC 300.

TABLE 1
ECG-AI Performance

| | ROC | Sensitivity | Specificity | Accuracy |
|---|---|---|---|---|
| ECG-AI | 0.77 | 90%, | 38% | 44% |
| ECG-AI + age & sex | 0.83 | 90% | 56% | 60% |
| ECG-AI, + age & sex + | 0.83 | 90% | 57% | 61% |
| other CV risk factor | | | | |

Algorithm's area under the receiving operating characteristics curve (ROC), sensitivity, specificity, and accuracy for CAC score 300

A deep learning-enabled ECG algorithm can help predict a high CAC score, even without any additional information about modifiable CV risk factors. Accordingly, the algorithm could be used to improve the selection of subjects with a higher likelihood of having a high CAC.

All publications (including patents, patent applications and sequence accession numbers mentioned herein) are hereby incorporated by reference in their entirety as if each individual publication was specifically and individually indicated to be incorporated by reference. In case of conflict, the present application, including any definitions herein, will control.

Those skilled in the art will recognize or be able to ascertain using no more than routine experimentation, many equivalents to the specific embodiments of the invention described herein. Such equivalents are intended to be encompassed by the following claims.

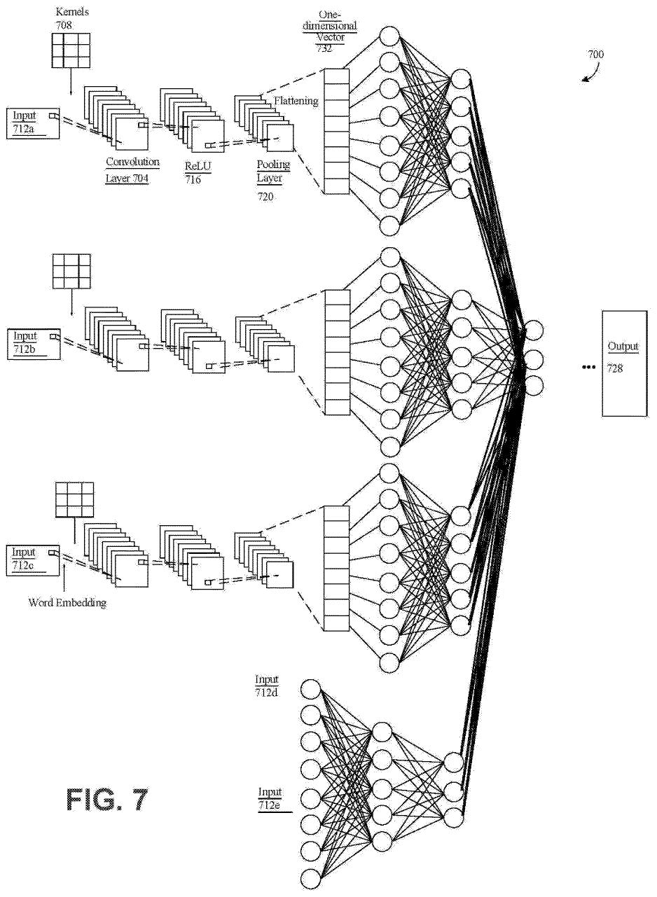

Referring now to FIG. 7, in an embodiment, learning system 104 may include a convolutional neural network (CNN) architecture 700 comprising a plurality of parallel convolutional pathways configured to process respective inputs 712a-712e. As a non-limiting example, inputs 712a-712e may include image data, textual data, numerical data, temporal data, and the like. For example, and without limitation, input 712a may include MRI image, input 712b may include ECG image, input 712c may include texts from EHR or doctor's note, input 712d may include patient data, and input 712e may include genome data. Each pathway may include a CNN designed to extract spatial hierarchies of features from corresponding input data through learned convolutional operations. For the purposes of this disclosure, a “convolutional neural network” is a neural network architecture characterized by the presence of one or more convolutional layers, where each convolutional layer performs localized operations to detect patterns within the input. A “kernel,” for the purposes of this disclosure, is defined as a small matrix of learnable weights that slides across the input data, performing an element-wise multiplication and summation at each spatial location to generate a feature map. The convolution operation occurs explicitly within the convolutional layers 704, wherein each application of the kernel 708 detects specific localized features such as edges or simple textures by systematically scanning across the height and width of the respective inputs 712a-712c.

Still referring to FIG. 7, each convolutional layer 704 may form an initial operation within a corresponding CNN pathway of architecture 700, directly applying the kernel 708 over a respective input 712a-e through a sliding window mechanism. At each spatial location, the kernel 708 and the corresponding patch of input 712a-e are multiplied element-wise and summed, producing a single value within the resulting feature map. This process, repeated across each respective input 712, enables the CNN architecture 700 to transform raw data into intermediate representations that highlight important local patterns. Following the convolution operation, the feature maps are passed through a non-linear activation function, such as a Rectified Linear Unit (ReLU) 716, to introduce non-linearity into the model, allowing for the learning of more complex and abstract features.

With continued reference to FIG. 7, additionally, or alternatively, each CNN pathway may further include one or more pooling layers 720 configured to reduce the spatial dimensions of the generated feature maps while retaining the most salient information. For the purposes of this disclosure, a “pooling layer” is a layer that applies a fixed function to small regions of feature maps, summarizing the presence of features over localized areas. As a non-limiting example, the fixed function may include maximum selection or averaging. Pooling operations, such as max pooling, reduce the computational load for subsequent layers, improve generalization by promoting translation invariance, and help mitigate overfitting by condensing feature representations. In some embodiments, pooling layers 720 may be interleaved between multiple convolutional layers 704 within each pathway to progressively abstract and distill the features extracted by the kernels 708 applied earlier in the network.

With continued reference to FIG. 7, in an embodiment, the sequence of convolutional and pooling layers 720 within each pathway allows the CNN architecture 700 to learn increasingly complex feature hierarchies. Initial convolutional layers 704 may focus on simple patterns like edges and gradients, while deeper layers may combine these lower-level patterns into higher-level features representing meaningful parts of the respective inputs 712. Pooling layers 720, placed strategically throughout each pathway, ensure that the computational complexity remains manageable and that the learned representations are robust to small variations in the inputs 712. Thus, through the structured application of convolution and pooling operations across multiple parallel pathways, CNN architecture 700 can achieve powerful feature extraction capabilities.

With continued reference to FIG. 7, in an embodiment, parameters associated with the convolution operation, such as stride and padding, may be utilized within each pathway to control the spatial dimensions and structure of the resulting feature maps. For the purposes of this disclosure, a “stride” is defined as the number of pixels by which a kernel moves after each application of a convolution operation. In some embodiments, a stride of one may be used to ensure that the kernel 708 slides over the input 712a-d one pixel at a time, thereby producing a dense feature map. Increasing the stride value results in fewer applications of the kernel 708 across the input 712a-d, which reduces the size of the feature map and can introduce a form of downsampling within the convolutional layer 704 itself. Additionally, or alternatively, “padding” may be applied to the input 712a-d, wherein additional pixels, typically initialized to zero, are added around the boundary of the input 712a-d. Padding may be used to preserve the spatial dimensions of the input 712a-d following the convolution operation, thereby ensuring that the feature maps retain sufficient resolution for deeper network layers. Through adjustment of stride and padding parameters, CNNs may flexibly manage the resolution, computational cost, and abstraction of spatial features extracted from inputs 712a-d.

With continued reference to FIG. 7, in an embodiment, each pathway may include a sequence of multiple convolutional and pooling layers 720 arranged in a hierarchical manner to enable progressively deeper feature extraction. In early layers, convolutional operations may detect simple spatial patterns such as edges and textures, while in deeper layers, the network may combine these lower-level patterns into more abstract representations. Each successive convolutional layer 704 operates on the feature maps generated by the preceding layer within each pathway, allowing the network to learn increasingly rich and complex feature hierarchies across multiple levels of abstraction. Pooling layers 720, interspersed between convolutional layers 704, serve to reduce the spatial dimensions of the feature maps, making it computationally feasible to construct deep architectures without an excessive increase in parameters or resource requirements.

With continued reference to FIG. 7, in an embodiment, after passing through multiple convolutional and pooling layers 720 within each pathway, the extracted features may be flattened into respective one-dimensional vectors 732 and provided to one or more fully connected layers. The outputs of the plurality of pathways may be combined, for example via concatenation or aggregation, prior to or within the fully connected layers configured to perform high-level reasoning and generate final outputs 728. As a non-limiting example, final output 728 may include any output described with respect to FIGS. 1A-B. For example, and without limitation, output 728 may include indication of cardiovascular risk, MACE, and the like. For the purposes of this disclosure, a “fully connected layer” is defined as a layer in which each neuron is connected to every neuron in the preceding layer, thereby enabling the combination of features extracted from the plurality of inputs 712a-712e into a comprehensive representation. Fully connected layers enable the CNN architecture 700 to synthesize the learned spatial features into a global interpretation of the inputs, facilitating complex decision-making processes. Additionally, or alternatively, activation functions such as Rectified Linear Unit (ReLU) 716 may be applied within fully connected layers, and regularization techniques such as dropout may be employed to prevent overfitting.

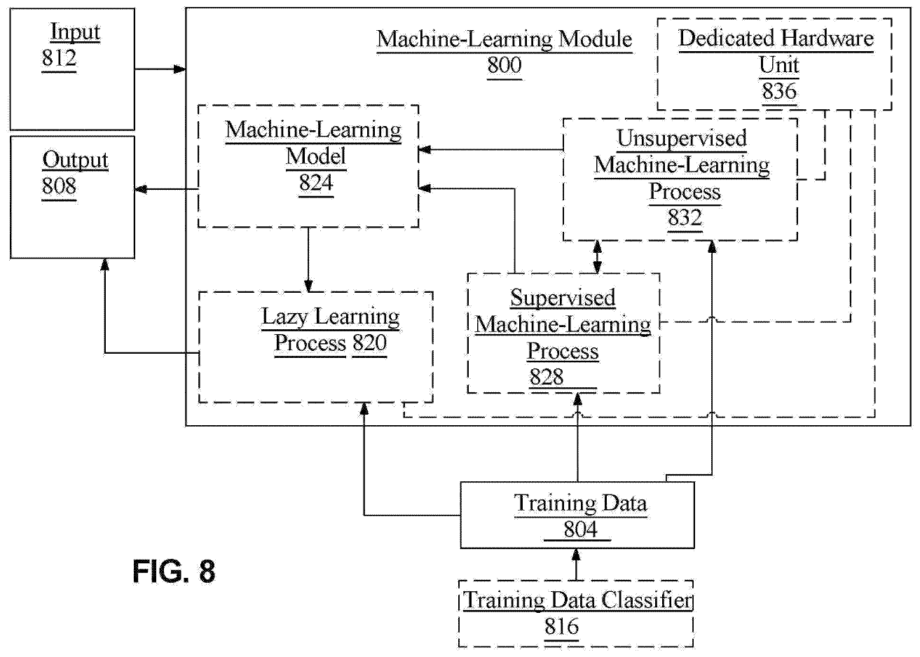

Referring now to FIG. 8, an exemplary embodiment of a machine-learning module 800 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 804 to generate an algorithm instantiated in hardware or software logic, data structures, and/or functions that will be performed by a computing device/module to produce outputs 808 given data provided as inputs 812; this is in contrast to a non-machine learning software program where the commands to be executed are determined in advance by a user and written in a programming language.

Still referring to FIG. 8, “training data,” as used herein, is data containing correlations that a machine-learning process may use to model relationships between two or more categories of data elements. For instance, and without limitation, training data 804 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 804 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 804 according to various correlations; correlations may indicate causative and/or predictive links between categories of data elements, which may be modeled as relationships such as mathematical relationships by machine-learning processes as described in further detail below. Training data 804 may be formatted and/or organized by categories of data elements, for instance by associating data elements with one or more descriptors corresponding to categories of data elements. As a non-limiting example, training data 804 may include data entered in standardized forms by persons or processes, such that entry of a given data element in a given field in a form may be mapped to one or more descriptors of categories. Elements in training data 804 may be linked to descriptors of categories by tags, tokens, or other data elements; for instance, and without limitation, training data 804 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 8, training data 804 may include one or more elements that are not categorized; that is, training data 804 may not be formatted or contain descriptors for some elements of data. Machine-learning algorithms and/or other processes may sort training data 804 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 804 to be made applicable for two or more distinct machine-learning algorithms as described in further detail below. Training data 804 used by machine-learning module 800 may correlate any input data as described in this disclosure to any output data as described in this disclosure. As a non-limiting illustrative example, input data may include voltage-time data from a multi-lead electrocardiogram, demographic data associated with a subject, genomic data associated with the subject, clinical risk-factor data, historical electrocardiogram data, and reference data obtained from an electronic health record, a datastore, or another computing system, As a non-limiting illustrative example, output data may include an indication of a level of coronary artery calcium, an indication of a regional wall motion abnormality, an indication of cardiovascular risk, a classification identifying no additional risk, increased risk, or substantially increased risk, a likelihood of a major adverse cardiovascular event occurring within a future time interval, a treatment recommendation, or combinations thereof.

Further referring to FIG. 8, training data may be filtered, sorted, and/or selected using one or more supervised and/or unsupervised machine-learning processes and/or models as described in further detail below; such models may include without limitation a training data classifier 816. Training data classifier 816 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 800 may generate a classifier using a classification algorithm, defined as a processes whereby a computing device and/or any module and/or component operating thereon derives a classifier from training data 804. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 816 may classify elements of training data to subject cohort including, but not limited to, subject demographics, medical history, and the like.

Still referring to FIG. 8, a computing device may be configured to generate a classifier using a Naive Bayes classification algorithm. Naive Bayes classification algorithm generates classifiers by assigning class labels to problem instances, represented as vectors of element values. Class labels are drawn from a finite set. Naive Bayes classification algorithm may include generating a family of algorithms that assume that the value of a particular element is independent of the value of any other element, given a class variable. Naive Bayes classification algorithm may be based on Bayes Theorem expressed as P(A/B)=P(B/A) P(A)−P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naive Bayes algorithm may be generated by first transforming training data into a frequency table. Computing device may then calculate a likelihood table by calculating probabilities of different data entries and classification labels. A computing device may utilize a naive Bayes equation to calculate a posterior probability for each class. A class containing the highest posterior probability is the outcome of prediction. Naive Bayes classification algorithm may include a gaussian model that follows a normal distribution. Naive Bayes classification algorithm may include a multinomial model that is used for discrete counts. Naive Bayes classification algorithm may include a Bernoulli model that may be utilized when vectors are binary.

With continued reference to FIG. 8, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 8, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {{a}_{i}}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 8, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 8, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 8, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 8, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 8, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 8, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 8, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 8, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 8, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 8, machine-learning module 800 may be configured to perform a lazy-learning process 820 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 804. Heuristic may include selecting some number of highest-ranking associations and/or training data 804 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 8, machine-learning processes as described in this disclosure may be used to generate machine-learning models 824. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 824 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 824 may be generated by creating an artificial neural network, such as a convolutional neural network comprising an input layer of nodes, one or more intermediate layers, and an output layer of nodes. Connections between nodes may be created via the process of “training” the network, in which elements from a training data 804 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 8, machine-learning algorithms may include at least a supervised machine-learning process 828. At least a supervised machine-learning process 828, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include voltage-time data from a multi-lead electrocardiogram, demographic data associated with a subject, genomic data associated with the subject, clinical risk-factor data, historical electrocardiogram data, and reference data obtained from an electronic health record, a datastore, or another computing system, as described above as inputs, an indication of a level of coronary artery calcium, an indication of a regional wall motion abnormality, an indication of cardiovascular risk, a classification identifying no additional risk, increased risk, or substantially increased risk, a likelihood of a major adverse cardiovascular event occurring within a future time interval, a treatment recommendation, or combinations thereof as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 804. Persons skilled in the art, upon reviewing the entirety of this disclosure, will be aware of various possible variations of at least a supervised machine-learning process 828 that may be used to determine relation between inputs and outputs. Supervised machine-learning processes may include classification algorithms as defined above.

With further reference to FIG. 8, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Continuing to refer to FIG. 8, evaluation of error function and/or other comparison results may include comparison of each of error function and/or other comparison results to a maximum single error threshold; in other words, a criterion of evaluation may include performing iterative retraining if any single comparison and/or error function output exceeds maximum single error threshold or if a count of single comparison and/or error function outputs exceeding single error threshold exceeds a threshold number and/or proportion of overall error function and/or other comparison results. Alternatively or additionally, evaluation of error function and/or other comparison results may include comparison of an aggregated plurality of error function and/or other comparison results to an aggregate error threshold; in other words, a criterion of evaluation may include performing iterative retraining if a result of averaging or otherwise aggregating a plurality such as some or all evaluated function and/or other comparison results exceeds aggregate error threshold. Aggregation may be performed in any manner of aggregation described in this disclosure and/or any combination thereof. Criteria for evaluations may be evaluated separately such that failing any one criterion causes iterative retraining; alternatively or additionally evaluation results may be combined according to one or more logical or other rules.

As a non-limiting, illustrative example, and still referring to FIG. 8, where outputs to be compared by error function are numerical values, error function may include subtraction of one from the other to derive an absolute value and/or mean squared error. Where outputs and/or training examples are represented as a binary classification, an error function may include a hinge loss function, sigmoid cross entropy loss function, weighted cross entropy loss function, or the like. Where output and/or exemplary output in a training set is a classification to three or more values, error function may include a softmax cross entropy loss function, a sparse cross entropy loss function, a Kullback-Leibler divergence loss function, or the like. Where both retaining and training with include supervised training, retraining may use a different error function, different weight update functions and/or parameters, or the like than in the training stage. For instance, and without limitation, when a previous iterative retraining process included training using examples from until a first convergence threshold and/or epsilon value and/or neighborhood is met, a subsequent iterative retraining process may include a lower convergence threshold, a smaller value of epsilon, or the like. Iterative retraining may include using one or more examples that were not used in any previous training and/or retraining process; for instance, where convergence was initially and/or previously achieved using a first subset of examples a subsequent retraining process may use examples from a second subset of examples, which may be wholly disjoint from first subset and/or have one or more elements that are not found in first subset.

Still referring to FIG. 8, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 8, machine learning processes may include at least an unsupervised machine-learning processes 832. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 832 may not require a response variable; unsupervised processes 832 may be used to find interesting patterns and/or inferences between variables, to determine a degree of correlation between two or more variables, or the like.

Still referring to FIG. 8, machine-learning module 800 may be designed and configured to create a machine-learning model 824 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 8, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 8, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 8, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 8, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 8, one or more processes or algorithms described above may be performed by at least a dedicated hardware unit 836. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 836 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 836 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 836 to perform one or more operations described herein, such as evaluation of model and/or algorithm outputs, one-time or iterative updates to parameters, coefficients, weights, and/or biases, and/or any other operations such as vector and/or matrix operations as described in this disclosure.

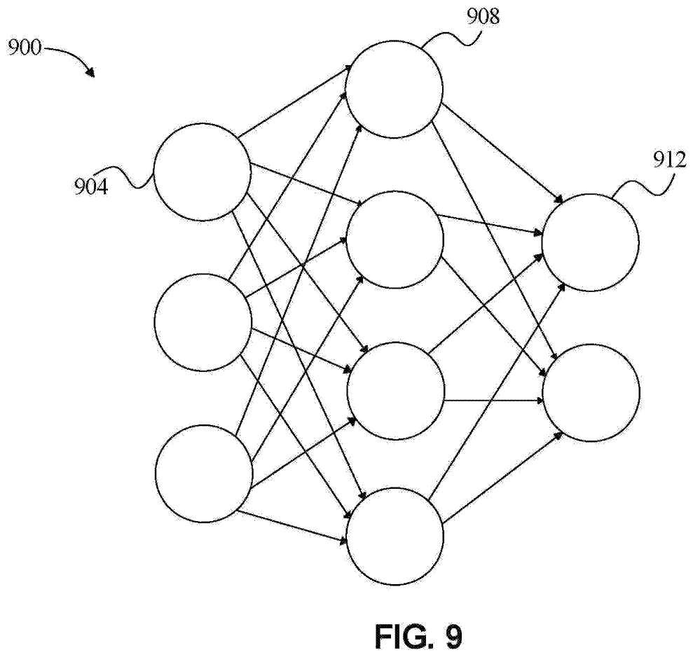

Referring now to FIG. 9, an exemplary embodiment of neural network 900 is illustrated. A neural network 900 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 904, one or more intermediate layers 908, and an output layer of nodes 912. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

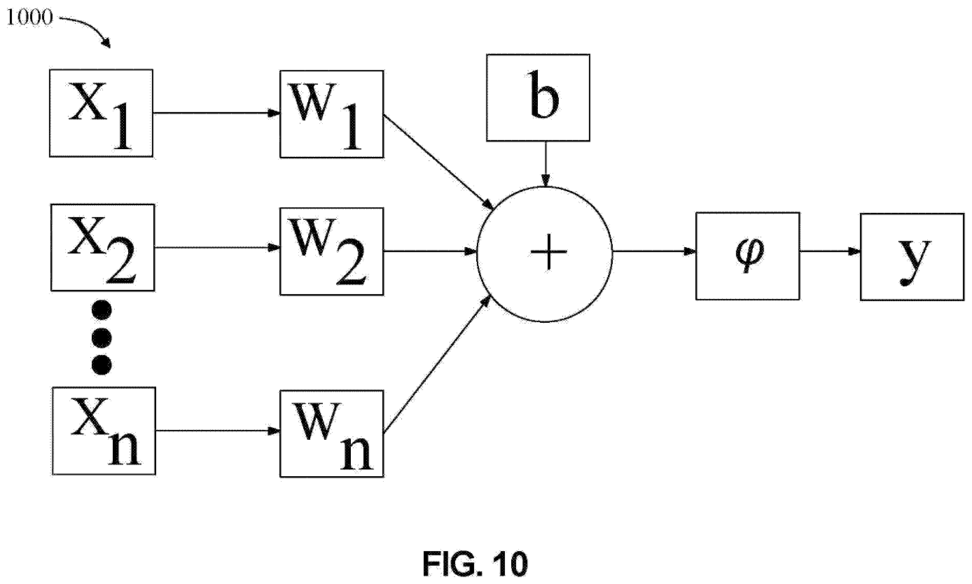

Referring now to FIG. 10, an exemplary embodiment of a node 1000 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as

$$f ( x ) = a ( 1 + tanh ( \sqrt{2 / π} ( x + {bx}^{r} ) ) )$$

for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix}$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{new} = {w}_{old} - α \frac{dJ}{dw}$$

where w_{new} is the updated weight value, w_{old} is the previous weight value, α is a parameter to set the learning rate, and

$$\frac{d J}{d w}$$

is the partial derivative of with respect to weight w.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

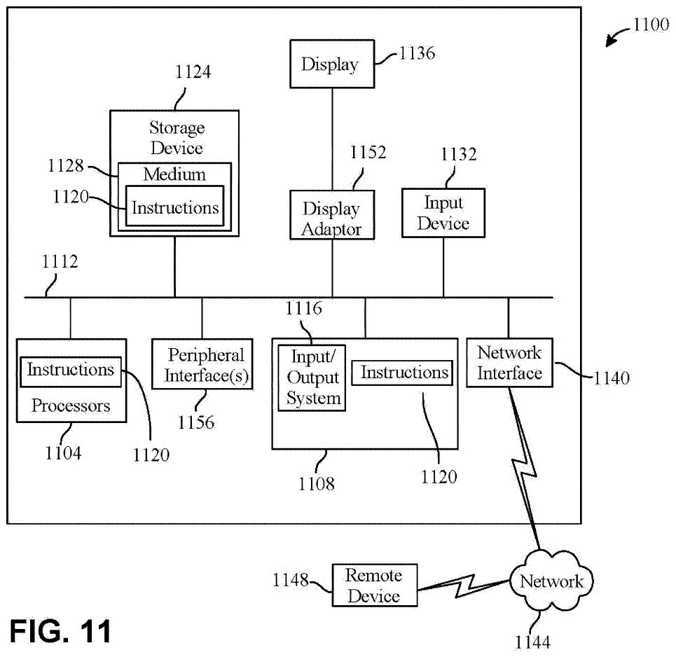

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof. Memory 1108 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In some embodiments, storage device 1124 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display 1136. Examples of a display device include, but are not limited to, a liquid crystal display (LCD), a cathode ray tube (CRT), a plasma display, a light emitting diode (LED) display, and any combinations thereof. Display adapter 1152 and display 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

Further referring to FIG. 11, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 11, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 11, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1100, processor 1104, and memory 1108 may be virtualized; that is, a virtual machine and/or container may interact directly with such computing system 1100, processor 1104, and/or memory 1108, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1104 comprises a plurality of processors and/or processor cores, virtualization may, in some cases, simulate or emulate a single (virtual) processor whose functions are allocated to one or more of the plurality of processors and/or processor cores. In this case, while processor 1104 may be said to be virtualized, the processor 1104, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and systems according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of electrocardiographic prediction of computed tomography-based high coronary calcium score, wherein the method comprises:
receiving, using at least a processor, voltage-time data of a subject, wherein the voltage-time data comprises voltage data from a plurality of leads;
generating, using the at least a processor, a feature vector as a function of the voltage-time data, wherein the feature vector comprises one or more time-series of values indicating an amplitude of an electrocardiogram (ECG) for the plurality of leads;
processing, using the at least a processor and a trained learning system comprising one or more convolutional neural networks (CNNs), the feature vector to generate one or more CNN outputs associated with the subject, wherein:
the one or more CNNs comprise a first CNN configured to generate an indication of a level of coronary artery calcium (CAC); and
determining, using the at least a processor, an indication of cardiovascular risk for the subject as a function of the one or more CNN outputs, wherein the indication of cardiovascular risk corresponds to a likelihood of the subject having or developing a cardiovascular condition within a future time interval.

2. The method of claim 1, wherein the method further comprises:
receiving, using the at least a processor, demographic data associated with the subject; and
generating, using the at least a processor, the feature vector as a function of the demographic data and the voltage-time data.

3. The method of claim 1, wherein the method further comprises:
receiving, using the at least a processor, genomic data associated with the subject; and
generating, using the at least a processor, the feature vector as a function of the genomic data and the voltage-time data.

4. The method of claim 1, wherein the voltage-time data of the subject is received from an electronic medical record.

5. The method of claim 1, wherein the method further comprises:
determining, using the at least a processor, a treatment plan for the subject in response to one or more CNN outputs.

6. The method of claim 1, wherein the method further comprises:
processing, using a second CNN of the one or more CNNs, the feature vector to generate an indication of a regional wall motion abnormality associated with the subject of the one or more decision outputs.

7. The method of claim 6, wherein determining the indication of cardiovascular risk comprises determining the indication of cardiovascular risk as a function of the indication of the level of CAC and the indication of the regional wall motion abnormality.

8. The method of claim 1, wherein the indication of cardiovascular risk comprises a ternary classification comprising no additional risk identified, increased risk, and substantially increased risk.

9. The method of claim 8, wherein:
the increased risk of the ternary classification indicates that the subject has a higher rate of atherosclerotic cardiovascular disease (ASCVD) events; and
the substantially increased risk of the ternary classification indicates that the subject has a higher rate of ASCVD events and a shorter time to an ASCVD event.

10. The method of claim 1, wherein the indication of cardiovascular risk corresponds to a likelihood of a major adverse cardiovascular event (MACE) occurring within the future time interval, wherein the MACE comprises at least one of acute myocardial infarction, acute ischemic stroke, and death due to the acute myocardial infarction or the acute ischemic stroke.

11. A system for electrocardiographic prediction of computed tomography-based high coronary calcium score, wherein the system comprises:
at least a processor;
a computer readable storage medium communicatively connected to the at least a processor, wherein the computer readable storage medium contains instructions configuring the at least processor:
receive voltage-time data of a subject, wherein the voltage-time data comprises voltage data from a plurality of leads;
generate a feature vector as a function of the voltage-time data, wherein the feature vector comprises one or more time-series of values indicating an amplitude of an electrocardiogram (ECG) for the plurality of leads;
process, using a trained learning system comprising one or more convolutional neural networks (CNNs), the feature vector to generate one or more CNN outputs associated with the subject, wherein:
the one or more CNNs comprise a first CNN configured to an indication of a level of coronary artery calcium (CAC); and
determine an indication of cardiovascular risk for the subject as a function of the one or more CNN outputs, wherein the indication of cardiovascular risk corresponds to a likelihood of the subject having or developing a cardiovascular condition within a future time interval.

12. The system of claim 11, wherein the computer readable storage medium contains further instructions configuring the at least a processor to:
receive demographic data associated with the subject; and
generate the feature vector as a function of the demographic data and the voltage-time data.

13. The system of claim 11, wherein the computer readable storage medium contains further instructions configuring the at least a processor to:
receive genomic data associated with the subject; and
generate the feature vector as a function of the genomic data and the voltage-time data.

14. The system of claim 11, wherein receiving the voltage-time data of the subject comprises receiving the voltage-time data of the subject from an electronic medical record.

15. The system of claim 11, wherein the computer readable storage medium contains further instructions configuring the at least a processor to determine a treatment plan for the subject in response to the one or more CNN outputs.

16. The system of claim 11, wherein the trained learning system further comprises a second CNN configured to process the feature vector to generate an indication of a regional wall motion abnormality associated with the subject.

17. The system of claim 16, wherein determining the indication of cardiovascular risk comprises determining the indication of cardiovascular risk as a function of the indication of the level of CAC and the indication of the regional wall motion abnormality.

18. The system of claim 11, wherein the indication of cardiovascular risk comprises a ternary classification comprising no additional risk identified, increased risk, and substantially increased risk.

19. The system of claim 18, wherein:
the increased risk of the ternary classification indicates that the subject has a higher rate of atherosclerotic cardiovascular disease (ASCVD) events; and
the substantially increased risk of the ternary classification indicates that the subject has a higher rate of ASCVD events and a shorter time to an ASCVD event.

20. The system of claim 11, wherein the indication of cardiovascular risk corresponds to a likelihood of a major adverse cardiovascular event (MACE) occurring within the future time interval, wherein the MACE comprises at least one of acute myocardial infarction, acute ischemic stroke, and death due to the acute myocardial infarction or the acute ischemic stroke.
